(19) United States
(12) Patent Application Publication
(10) Pub. No.: US 2024/0231315 A9
(43) Pub. Date: Jul. 11, 2024

(54) SYSTEM AND METHOD FOR MINIMIZING GREENHOUSE GAS EMISSIONS DUE TO COMPONENT REPLACEMENT IN CLIENT INFORMATION HANDLING SYSTEMS

(71) Applicant: Dell Products, LP, Round Rock, TX (US)

(72) Inventors: Deeder M. Aurongzeb, Austin, TX (US); Malathi Ramakrishnan, Madurai (IN); Parminder Singh Sethi, Punjab (IN)

(73) Assignee: Dell Products, LP, Round Rock, TX (US)

(21) Appl. No.: 17/969,341

(22) Filed: Oct. 19, 2022

(51) Int. Cl. G05B 19/4155

(52) U.S. Cl. CPC G05B 19/4155; G05B 2219/40573

(57) ABSTRACT

A device refurbishment carbon dioxide (CO2) emissions minimization system of a unified endpoint management platform information handling system comprising a network interface device to receive operational telemetry measurements for a first client information handling system or device operated by a first user, including power analytics, software application analytics, a first user geographic location, and a determined CO2 emissions value exceeding a non-eco-friendly state transition threshold value, a hardware processor to identify, via a neural network modeling a relationship between CO2 emissions values and operational telemetry measurements, a first user geographic location based CO2 increase cause, to determine the first user geographic location has a temperature higher than a temperature for a second geographic location of a second device, and the network interface device to generate and transmit recommendation instructions to the second device that the first device replace the second device for the second user.

### FIELD OF THE DISCLOSURE

The present disclosure generally relates to determining an amount of greenhouse gas emissions that may be attributable to operation of an information handling system. More specifically, the present disclosure relates to a device refurbishment carbon dioxide (CO2) emissions minimization system for orchestrating by generating recommendation instructions for replacement of refurbished client information handling systems to users predicted to maintain the refurbished client information handling system in an eco-friendly CO2 emissions state, based on known usage patterns and temperature and humidity of user's geographic locations.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, video communication capabilities, and audio capabilities.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating a cloud-based Unified Endpoint Management (UEM) platform information handling system according to an embodiment of the present disclosure;

FIG. 2 is a block diagram illustrating a device refurbishment carbon dioxide (CO2) emissions minimization system executing on a UEM information handling system with client information handling systems according to an embodiment of the present disclosure;

FIG. 3 is a flow diagram illustrating a method of gathering power and application analytics for diagnosing a cause of increased CO2 emissions from operational telemetry of a client information handling system according to an embodiment of the present disclosure;

FIG. 4 is a flow diagram illustrating a method of identifying a candidate CO2 increase causative operational telemetry measurement for a transition to a non-eco-friendly CO2 emissions state according to an embodiment of the present disclosure; and

FIG. 5 is a flow diagram illustrating a method of orchestrating by generation of instructions of replacement of refurbished client information handling systems among users according to usage profiles according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

Consumers are placing an ever increasing value on minimizing greenhouse gas (GHG) emissions generated during manufacture and usage of products they purchase. In other words, the size of GHG emissions generated during manufacture or use of a product is projected to sway an end consumer's purchasing decision to an increasingly large degree over the coming years. One major impact on such GHG emissions is efficiency of device operation, including software application execution, hardware operation, and power consumption at end devices such as information handling systems operated by an end user. This efficiency measure may decrease when client information handling systems are used inefficiently or poorly maintained by a user (e.g., failure to update software or firmware, constant execution of background applications, high workload, maintaining multiple browsing sessions simultaneously, hardware components set to high performance mode rather than eco-friendly mode). These circumstances may be avoidable through warnings or recommendations provided to the user. However, this efficiency measure may also decrease as the client information handling system ages, due to unavoidable wear and tear on components. Goals may be set for capping CO2 emissions due to operation of each client information handling system that takes the age of the device and its components into account. Additionally, extending life of client information handling systems with replacement suited to performance or climate may avoid or postpone disposal that would require new information handling system manufacture and ultimately may assist in GHG emission reduction.

In various embodiments described herein, the life cycle of each client information handling system may be divided into three states. These states include a first, peak-health training state, immediately following initial purchase and use of the device, a monitoring second state in which the client information handling system consistently meets the goal for capping CO2 emissions, and a non-eco-friendly third state in which inefficient operation of the device unrelated to age causes the client information handling system to fail to meet that goal. Each of the threshold CO2 emissions values defining these states may be unique to each client information handling system and may take into account the age of each device. For example, the first state may be defined by a maximum value of pounds of CO2 emitted per hour measured during a preset three or six month period following initial operation of the client information handling system. During this first state, it is assumed that the client information handling system is working at peak efficiency. In other words, it is assumed that the client information handling system is not experiencing efficiency loss due to age or due to inefficient use of the device. This first state threshold maximum value of pounds of CO2 emitted per hour may provide a benchmark against which future efficiency of the client information handling system may be measured. CO2 emission will also be impacted by client information handling system workload requirements as well as location climate considerations.

As described above, some decrease in operational efficiency at each client information handling system is unavoidable due to wear and tear of components, such as, for example, the battery. Thus, the CO2 emitted per hour is expected to increase over time, even when the client device is being used as efficiently as possible, due to decreased efficiency of the battery as it ages. In other words, even if the updating and execution of software and firmware and power consumption of various components are optimized for minimizing CO2 emissions, increases in CO2 emissions during operation of the client information handling system will still occur. Such unavoidable increases in CO2 emissions due to aging are differentiated from further increases in CO2 emissions due to avoidable inefficient usage of the client information handling system (e.g., due to failure to perform updates, non-optimized execution of software or firmware, or non-eco-friendly power consumption by hardware components) in embodiments of the present disclosure.

The second state in embodiments of the present disclosure defines a maximum CO2 emissions value for the client information handling system when the device is being used as efficiently as possible, but that also takes into account the age of the client information handling system and its components (e.g., battery). This maximum CO2 emissions value defining the second state in embodiments may be referred to herein as a non-eco-friendly state transition threshold value, before transition to a third-non-eco-friendly state. For example, the non-eco-friendly state transition threshold value in embodiments may be determined by weighting the threshold maximum CO2 emissions value defining the first state (e.g., in which the client information handling system is assumed to be operating at peak efficiency, optimized to minimize CO2 emissions) by a decrease in efficiency of the battery due to age. When operation of the client information handling system causes emission of CO2 beyond this non-eco-friendly state transition threshold value, the client information handling system may pass from the second state to the third, non-eco-friendly state, in which inefficient operation of the device unrelated to age causes increased CO2 emissions. In such a way, the recommendation agent may estimate CO2 emissions for optimally efficient usage of the client information handling system, given the unavoidable drop in efficiency of its battery, when operating in the second state.

In other embodiments of the present disclosure, a cloud-based device refurbishment CO2 emissions minimization system operating at a Unified Endpoint Management (UEM) platform may optimize replacement of refurbished client information handling systems that have reached the third, non-eco-friendly CO2 emissions state due to high workload or usage in a high temperature or high humidity geographic region and extend the usable life of such client information handling systems. The device refurbishment CO2 emissions minimization system in embodiments described herein may orchestrate, by generating instructions for refurbishment and replacement of such client information handling systems to geographic locations or users where the client information handling systems is predicted to maintain an eco-friendly CO2 emissions state one or two and may continue use. For example, the device refurbishment CO2 emissions minimization system in embodiments in which the client information handling system is determined to have crossed into the non-eco-friendly CO2 emissions state three due to high temperature or humidity may orchestrate, by generating instructions for replacement of the client information handling system to a geographic area having a lower temperature or humidity. As another example, the device refurbishment CO2 emissions minimization system in embodiments in which the client information handling system is determined to have crossed into the non-eco-friendly CO2 emissions state three due to high workload at one or more specific hardware components, or from specific software applications may orchestrate, by generating instructions for replacement of the client information handling system to users associated with user profiles indicating that the new user may use the client information handling system for other purposes, that may not be likely to place a similarly high workload on the system or specific components. Replacement may include switching out systems within a managed enterprise to find a user or location to extend life of a client information handling system that may be refurbished in some embodiments. In other embodiments, replacement may include monitoring by a manufacturer of information handling systems for a location or user where the replacement client information handling system may be placed or resold and still maintain an eco-friendly CO2 emissions state one or two.

A CO2 optimization engine also operating at the UEM platform in embodiments described herein may predict what has caused the client information handling system that is to be refurbished to cross into the non-eco-friendly CO2 emissions state three using a neural network modelling a relationship between changes in CO2 emissions values and changes in client device operational telemetry measurements. In particular, user-adjustable operational telemetry measurements that may be affected by a command to alter function or operations of components of the client information handling system. In a particular embodiment, this modelled relationship between CO2 emissions and changes in operational telemetry may be modeled based on client information handling systems having similar usage profiles or usage purposes for client information handling systems.

The cloud-based CO2 optimization engine in various embodiments may then use this modeled relationship to identify one or more changes in power measurements, software analytics measurements, or error log events that could cause an individual client information handling system to cross from the second state to the non-eco-friendly third state. For example, the cloud-based CO2 optimization engine in embodiments may predict that failure of a specifically identified hardware component, increased power consumption by a specific hardware component, high workload by a specific software application, failure to perform a critical update to firmware, or continued uncapped usage of a hardware component or of background software applications may have caused the detected transition from the second state to the third state at a particular client information handling system. The device refurbishment CO2 emissions minimization system in embodiments described herein may then identify a usage profile of a second user of location. It may be determined from this second usage profile that there is little or no threat that the associated second user may expose the client information handling system to the same type of operational telemetry measurements identified as a likely cause of the transition to the non-eco-friendly CO2 emissions state. In such a way, the device refurbishment CO2 emissions minimization system in embodiments of the present disclosure may orchestrate, by generating instructions for refurbishment and replacement of a client information handling system to users likely to maintain the client information handling system within the eco-friendly CO2 emissions state one or two without adjusting hardware configuration or intended usage of the client information handling system for these users or at the new location.

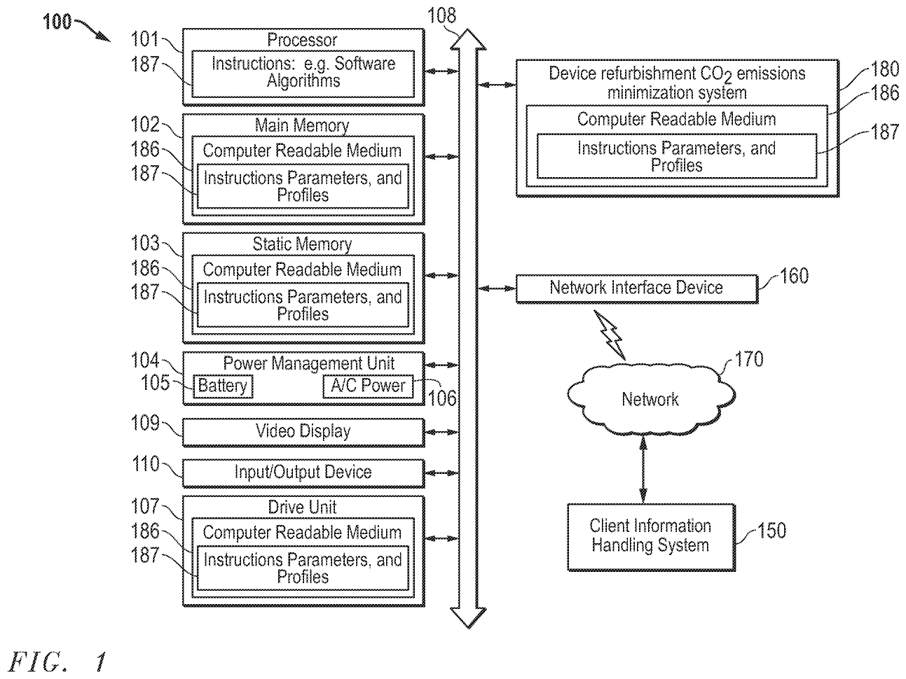

FIG. 1 illustrates an information handling system 100 according to several aspects of the present disclosure. As described herein, a cloud-based device refurbishment CO2 emissions minimization system 180 operating at a Unified Endpoint Management (UEM) platform information handling system may orchestrate, by generating instructions for refurbishment and replacement of client information handling systems (e.g., 150) to users likely to maintain the client information handling system (e.g., 150) within the eco-friendly CO2 emissions state one or two without adjusting hardware configuration or intended usage of the client information handling system (e.g., 150). The non-eco-friendly state transition threshold value may be determined by the recommendation agent at that client information handling system 150 and attributed to inefficiencies not only related to age of the client information handling system (e.g., 150) or its various hardware components, in some embodiments herein. Client device operational telemetry measurements, both user-adjustable and other operational telemetry measurements, include power analytics, software application analytics, and event viewer error logs, as well as determined CO2 emissions values and state transition threshold values particular to each client information handling systems (e.g., 150). These operational telemetry measurements may be gathered during routine monitoring periods from a plurality of client information handling systems (e.g., 150) at the UEM platform 100 executing the cloud-based device refurbishment CO2 emissions minimization system 180. Some or all of the information handling system 100 described in FIG. 1 may operate as a UEM platform information handling system in some embodiments. Some or all of the information handling system 100 described in FIG. 1 may also represent a client information handling system according to various embodiments herein.

Using these crowd-sourced operational telemetry measurements from a plurality of client information handling systems (e.g., 150), and CO2 emissions values, the cloud-based device refurbishment CO2 emissions minimization system 180 executing on a hardware processor 101 in embodiments herein may use a crowd-source trained feed-forward neural network modelling a relationship between changes in CO2 emissions values and changes in client device operational telemetry measurements, including user-adjustable operational telemetry measurements. The trained feed-forward neural network of the device refurbishment CO2 emissions minimization system 180 is used to identify one or more changes in power measurements, software analytics measurements, or error log events that could cause an individual client information handling system (e.g., 150) to cross from the second state to the non-eco-friendly third state. The cloud-based device refurbishment CO2 emissions minimization system 180 operating at the UEM platform 100 in an embodiment may then transmit remediation user instructions for pro-actively limiting the predicted transition to the non-eco-friendly CO2 emissions state three at the client information handling system (e.g., 150).

In a networked deployment, the information handling system 100 may operate in the capacity of a server or as a client computer in a server-client network environment, or as a peer computer system in a peer-to-peer (or distributed) network environment. In a particular embodiment, the information handling system 100 may be implemented using electronic devices that provide voice, video or data communication. The information handling system 100 may include a memory 102, (with computer readable medium 186 that is volatile (e.g. random-access memory, etc.), nonvolatile memory (read-only memory, flash memory etc.) or any combination thereof), one or more hardware processing resources, such as a central processing unit (CPU), a graphics processing unit (GPU), a Visual Processing Unit (VPU) or a Hardware Accelerator, any one of which may be the hardware processor 101 illustrated in FIG. 1, hardware control logic, or any combination thereof. Additional components of the information handling system 100 may include one or more storage devices 103 or 107, a wireless network interface device 160, one or more communications ports for communicating with external devices, as well as various input and output (I/O) devices 110, such as a keyboard, a mouse, touchpad or any combination thereof. A power management unit 104 supplying power to the information handling system 100, via a battery 105 or an alternating current (A/C) power adapter 106 may supply power to one or more components of the information handling system 100, including the hardware processor 101, or other hardware processing resources executing code instructions of the device refurbishment CO2 emissions minimization system 180, the wireless network interface device 160, a static memory 103 or drive unit 107, a, a video display 109 or other components of an information handling system. The video display 109 in an embodiment may function as a liquid crystal display (LCD), an organic light emitting diode (OLED), a flat panel display, or a solid-state display. The information handling system 100 may also include one or more buses (e.g., 108) operable to transmit communications between the various hardware components.

The information handling system 100 may execute code instructions 187, via one or more hardware processing resources, such as for the device refurbishment CO2 emissions minimization system 180, that may operate on servers or systems, remote data centers, or on-box in individual client information handling systems 100 according to various embodiments herein. In some embodiments, it is understood any or all portions of code instructions 187 may operate on a plurality of information handling systems 100.

The information handling system 100 may include a hardware processor 101 such as a central processing unit (CPU), a graphics processing unit (GPU), a Visual Processing Unit (VPU), or a hardware accelerator, embedded controllers or hardware control logic or some combination of the same. Any of the hardware processing resources may operate to execute code that is either firmware or software code. Moreover, the information handling system 100 may include memory such as main memory 102, static memory 103, containing computer readable medium 186 storing instructions 187. In other embodiments the information handling system 100 may represent a server information handling system executing a device refurbishment CO2 emissions minimization system 180, operating system (OS) software, application software, BIOS software, or other software applications or drivers detectable by hardware processor type 101.

The disk drive unit 107 and static memory 103 may also contain space for data storage in a computer readable medium 186. The instructions 187 in an embodiment may reside completely, or at least partially, within the main memory 102, the static memory 103, and/or within the disk drive 107 during execution by the hardware processor 101. The information handling system 100 may also include one or more buses 108 operable to transmit communications between the various hardware components such as any combination of various input and output (I/O) devices 110, or the like.

The network interface device 160 may provide connectivity of the information handling system 100 to the network 170 via a dedicated link, a network AP or base station in an embodiment. The network 170 in other embodiments may be a wired local area network (LAN), a wireless personal area network (WPAN), a wireless Local Area Network (WLAN), such as a public Wi-Fi communication network, a private Wi-Fi communication network, or other non-cellular communication networks. In other embodiments, the network 170 may be a wired wide area network (WAN), a wireless wide area network (WWAN), such as a 4G LTE public network, or a 5G communication network, or other cellular communication networks, including future protocol communication networks such as upcoming 6G protocols under development. Connectivity to any of a plurality of networks 170, one or more APs for those networks, or to a docking station in an embodiment may be via wired or wireless connection. In some aspects of the present disclosure, the network interface device 160 may operate two or more wireless links. In other aspects of the present disclosure, the information handling system 100 may include a plurality of network interface devices, each capable of establishing a separate wireless link to network 170, such that the information handling system 100 may be in communication with network 170 via a plurality of wireless links.

The network interface device 160 may operate in accordance with any cellular wireless data communication standards. To communicate with a wireless local area network, standards including IEEE 802.11 WLAN standards, IEEE 802.15 WPAN standards, or similar wireless standards may be used. Utilization of radiofrequency communication bands according to several example embodiments of the present disclosure may include bands used with the WLAN standards which may operate in both licensed and unlicensed spectrums. For example, WLAN may use frequency bands such as those supported in the 802.11 a/h/j/n/ac/ax including Wi-Fi 6 and Wi-Fi 6e. It is understood that any number of available channels may be available in WLAN under the 2.4 GHz, 5 GHz, or 6 GHz bands which may be shared communication frequency bands with WWAN protocols in some embodiments.

The network interface device 160, in other embodiments, may connect to any combination of cellular wireless connections including 2G, 2.5G, 3G, 4G, 5G or the like from one or more service providers or privately administered by an enterprise. Utilization of radiofrequency communication bands according to several example embodiments of the present disclosure may include bands used with the WWAN standards, which may operate in both licensed and unlicensed spectrums. More specifically, the network interface device 160 in an embodiment may transceive within radio frequencies associated with the 5G New Radio (NR) Frequency Range 1 (FR1) or Frequency Range 2 (FR2). NRFR1 may include radio frequencies below 6 GHz, also sometimes associated with 4G LTE and other standards predating the 5G communications standards. NRFR2 may include radio frequencies above 6 GHz, made available within the emerging 5G communications standard. Frequencies related to the 5G networks may include high frequency (HF) band, very high frequency (VHF) band, ultra-high frequency (UHF) band, L band, S band, C band, X band, Ku band, K band, Ka band, V band, W band, and millimeter wave bands.

In some embodiments, software, firmware, dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present embodiments encompass software, firmware, or hardware implementations.

In accordance with various embodiments of the present disclosure, the methods described herein may be implemented by firmware or software programs executable by a hardware controller, a hardware processor system, or other hardware processing resources. Further, in an exemplary, non-limited embodiment, implementations may include distributed processing, component/object distributed processing, and parallel processing. Alternatively, virtual computer system processing may be constructed to implement one or more of the methods or functionalities as described herein.

The present disclosure contemplates a computer-readable medium that includes instructions, parameters, and profiles 187 or receives and executes instructions, parameters, and profiles 187 responsive to a propagated signal, at a device connected to a network 170. Further, the instructions 187 may be transmitted or received over the network 170 via the network interface device 160. The information handling system 100 may include a set of instructions 187 that may be executed to cause the computer system to perform any one or more of the methods or computer-based functions disclosed herein, such as orchestrating, by generating recommendation instructions for refurbishment and replacement of client information handling systems (e.g., 150) to users likely to maintain the client information handling system (e.g., 150) within the eco-friendly CO2 emissions state one or two without adjusting hardware configuration or intended usage of the client information handling system (e.g., 150). For example, instructions 187 may include a particular example of a device refurbishment CO2 emissions minimization system 180, or other aspects or components. Various software modules comprising application instructions 187 may be coordinated by an operating system (OS), and/or via an application programming interface (API). An example operating system may include Windows®, Android®, and other OS types. Example APIs may include Win 32, Core Java API, or Android APIs. Application instructions 187 may also include any application processing drivers, or the like executing on information handling system 100.

The device refurbishment CO2 emissions minimization system 180 may utilize a computer-readable medium 186 in which one or more sets of instructions 187 may operate in part as software or firmware instructions executed via hardware processing resources on the information handling system 100. The instructions 187 may embody one or more of the methods as described herein. For example, code instructions relating to the device refurbishment CO2 emissions minimization system 180, firmware or software algorithms, processes, and/or methods may be stored here. Such code instructions 187 may comprise predicting and notifying a user when the client information handling system (e.g., 150) is likely to move from the second state to the third non-eco-friendly state by increasing CO2 emissions beyond the non-eco-friendly state transition threshold value due to inefficiencies not related to age of the client information handling system 150. The device refurbishment CO2 emissions minimization system 180 may operate on hardware processing resources within a Unified Endpoint Management (UEM) platform 100 that gathers telemetries from a plurality of client information handling systems (e.g., 150) endpoints via the network 170 that describe operating environments for those client information handling systems (e.g., 150). The UEM platform 100 in an embodiment may operate to identify information technology (IT) issues at client information handling systems 150, and to provide support for such issues, including automatically updating drivers or hardware components, as needed. The UEM platform in an embodiment may operate as a cloud-based service to store data (e.g., operating environment telemetries for remote client information handling systems 150) within memory 102, static memory 103, or computer readable medium 186 received via network 170. In some embodiments the information handling system 100 may be a server executing a UEM platform.

Main memory 102 may contain computer-readable medium (not shown), such as RAM in an example embodiment. An example of main memory 102 includes random access memory (RAM) such as static RAM (SRAM), dynamic RAM (DRAM), non-volatile RAM (NV-RAM), or the like, read only memory (ROM), another type of memory, or a combination thereof. Static memory 103 may contain computer-readable medium (not shown), such as NOR or NAND flash memory in some example embodiments. The instructions, parameters, and profiles 187 of the device refurbishment CO2 emissions minimization system 180 may be stored in static memory 103, or the drive unit 107 on a computer-readable medium 186 such as a flash memory or magnetic disk in an example embodiment. More specifically, telemetries describing heat measurements, executing software applications, and errors associated with one or more hardware components of client information handling systems (e.g., 150) may be stored within memory 102, static memory 103, or drive unit 107.

While the computer-readable medium is shown to be a single medium, the term “computer-readable medium” includes a single-medium or multiple-media, such as a centralized or distributed database, and/or associated caches and servers that store one or more sets of instructions. The term “computer-readable medium” shall also include any medium that is capable of storing, encoding, or carrying a set of instructions for execution by a hardware processor or that cause a computer system to perform any one or more of the methods or operations disclosed herein.

In a particular non-limiting, exemplary embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to store information received via carrier wave signals such as a signal communicated over a transmission medium. Furthermore, a computer readable medium may store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In some embodiments, dedicated hardware implementations such as application specific integrated circuits, programmable logic arrays and other hardware devices may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

When referred to as a “system”, a “device,” a “module,” a “controller,” or the like, the embodiments described herein may be configured as hardware, or as software or firmware executing on a hardware processing resource. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module may execute software, including firmware embedded at a device, such as an Intel® Core class hardware processor, ARM® brand hardware processors, Qualcomm Snapdragon hardware processors, or other hardware processors and chipsets, or other such device, or software capable of operating a relevant environment of the information handling system. The system, device, controller, or module may also comprise a combination of the foregoing examples of hardware, firmware, or software. In an embodiment an information handling system 150 may include an integrated circuit or a board-level product having portions thereof that may also be any combination of hardware and software. Devices, modules, resources, controllers, or programs that are in communication with one another need not be in continuous communication with each other, unless expressly specified otherwise. In addition, devices, modules, resources, controllers, or programs that are in communication with one another may communicate directly or indirectly through one or more intermediaries.

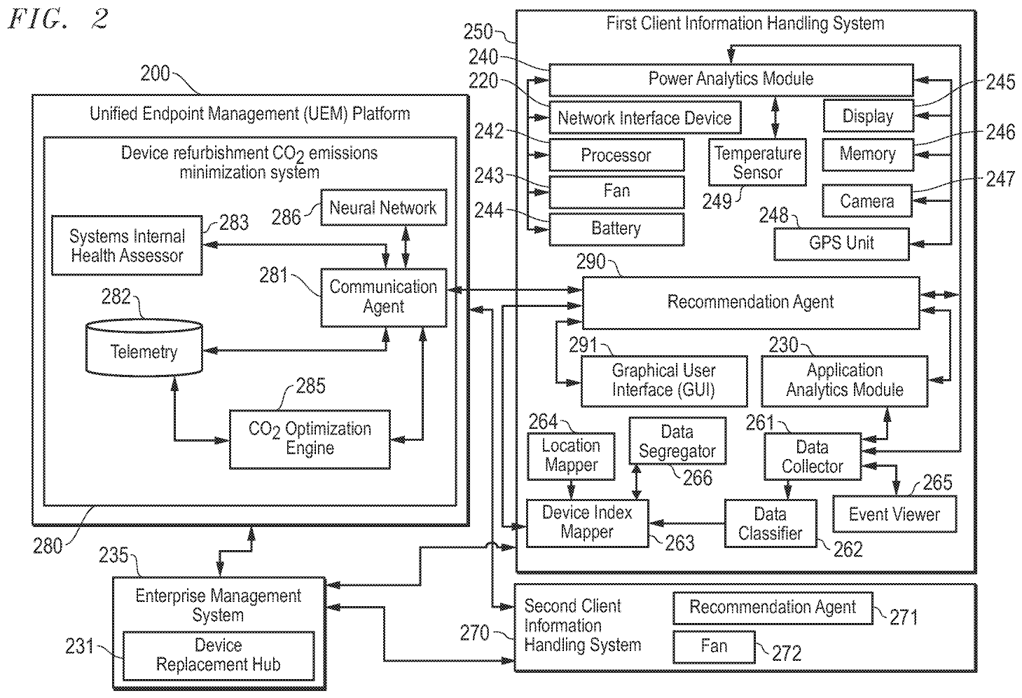

FIG. 2 is a block diagram illustrating a device refurbishment carbon dioxide (CO2) emissions minimization system 280 for orchestrating refurbishment and replacement of client information handling systems to geographic locations or users with usage profiles where the client information handling system is predicted to maintain an eco-friendly CO2 emissions state. A unified endpoint management (UEM) platform 200 in an embodiment may execute a device refurbishment CO2 emissions minimization system 280 to predict a cause for a previously occurring transition to a non-eco-friendly operational state for one of a plurality of client information handling systems (e.g., 250) under management of or in communication with an enterprise management system 235, which may act as an interface between the client information handling system (e.g., 250 or 270) and the UEM platform 200. The UEM platform 200 executing code instructions of the device refurbishment CO2 emissions minimization system 280 may generate and transmit a recommendation instruction to a user, an IT manager, to a prospective recipient or some combination to trigger a replacement of a client information handling system to a location or with a usage profile that will extend the life of the client information handling system operating at an eco-friendly CO2 emissions state one or two.

The UEM platform 200 in an embodiment may operate as a cloud-based service in communication with the enterprise management system 235 via a network to identify information technology (IT) issues at a first client information handling system 250, or a second client information handling system 270. The UEM platform 200 and enterprise management system 235 may also provide support for such issues, including automatically updating drivers or hardware components, as needed. In a specific embodiment of the present disclosure, the UEM platform 200 may gather operational telemetry measurements from a plurality of client information handling systems (e.g., 250 and 270) that describe operating environments for those client information handling systems (e.g., geographic location, power consumption analytics, failures or errors associated with one or more hardware components, or analytics for software usage).

A device refurbishment CO2 emissions minimization system 280 in an embodiment may use a crowd-source trained neural network 286 that models a relationship between changes in CO2 emissions values and changes in various operational telemetry measurements, including one or more that may be deemed user-adjustable with adjustments to client information handling system (e.g., 250) operation. For example, client information handling system operational telemetry measurements such as geographic location, power analytics, software analytics, error log events, and usage profiles may be used to predict the degree to which certain changes in operational efficiency of client information handling systems (e.g., 250 or 270) may increase CO2 emitted during such operation. These changes in operational efficiency in an embodiment may be represented by the various operational telemetry measurements as they change, such as changes to power analytics, software application analytics, and event viewer log entries. The UEM platform 200 may receive such operational telemetry measurements upon which such predictions may be made from a plurality of client information handling systems (e.g., 250 and 270), which may be managed by the same enterprise management system (e.g., 235), or may be managed by separate enterprise management systems in various embodiments.

Each client information handling system (e.g., 250 or 270) in an embodiment may include a plurality of hardware components. For example, a first client information handling system 250 in an embodiment may include a network interface device 220, a hardware processor (e.g., central processing unit (CPU), graphics processing unit (GPU), or visual processing unit (VPU)) 242, a display 245, a memory 246, a fan 243, and one or more components of a power supply unit (e.g., battery 244). In some embodiments, the first client information handling system 250 may further include one or more sensing devices, such as a location sensing devices 248 (e.g., GPS location unit), temperature sensor 249, or camera 247, which may also be used during execution of videoconferencing software applications, for example. In another embodiment, the first client information handling system 250 may further be operably connected to one or more peripheral devices, for example. Such an operably connection may employ a driver or firmware for such a peripheral device in such an embodiment. One or more of the other hardware components described herein (e.g., 220, 242, 243, 244, 245, 246, 247, 248, or 249) may further operate according to firmware or driver instructions in an embodiment.

A power analytics module 240 in an embodiment may be in communication with the various hardware components (e.g., 220, 242, 243, 244, 245, 246, 247, 248, or 249) and firmware for those components in an embodiment. For example, the power analytics module 240 may monitor power consumption by each of the various hardware components (e.g., 220, 242, 243, 244, 245, 246, 247, 248, or 249) in an embodiment. In another example embodiment, the power analytics module 240 may also access firmware for hardware components (e.g., 220, 242, 243, 244, 245, 246, 247, 248, or 249) to determine policies or settings for those components at the time of such power measurements. The power analytics module 240, along with the recommendation agent 290 may also receive remediation user instructions to adjust operation of the client information handling system pursuant to the device refurbishment CO2 emissions minimization system 280 determining actions to pro-actively limit a client information handling system reaching an unsustainable CO2 generation state (e.g., state three). These remediation user instructions may, or may not, be accepted by a user of a client information handling system.

More specifically, the power analytics module 240 in an embodiment may determine whether a network interface device 220 is transceiving according to WLAN, WWAN, Bluetooth®, Remote Desktop Protocol (RDP), or Near Field Communication (NFC) standards, as well as policies setting a preference for one type of standard over another, or restrictions on operation of the first client information handling system 250 as a mirror server, on allowing remote users to make calls to the hardware processor 242, or on power consumption, data rate, or frequencies used by the network interface device 220. In another example, the power analytics module 240 in an embodiment may determine current usage as a percentage of total capacity for the hardware processor 242 (e.g., central processing unit (CPU), graphics processing unit (GPU), or visual processing unit (VPU)). In still another example, the power analytics module may determine current usage as a percentage of total capacity for memory 246, time required to process requests to access such memory 246, and identify software applications most frequently accessing such memory 246. In yet another example, the power analytics module 240 in an embodiment may determine a usage mode for the display 245, such as day mode, night mode, power reserve mode, or gaming mode (e.g., high-resolution). In still another example embodiment, the power analytics module 240 may determine policies controlling the periods in which sensing hardware may be operational. More specifically, the power analytics module 240 in an embodiment may determine whether the location sensing device (e.g., GPS unit) 248, peripheral device 249, or camera 247 are set to remain on at all times, to operate only when a laptop or mobile information handling system is in a certain position (e.g., closed or open), to operate when a mobile device is currently moving, or to operate only when a user is actively executing software applications or certain software applications. In yet another embodiment, the power analytics module 240 may determine the media capture instructions setting for the camera 247, indicating a resolution of captured images, a frequency at which those images are captured, and any processing algorithms that may be applied to those images (e.g., zooming, cropping, background image application, boundary recognition, face recognition, smoothing, etc.). All information accessed in such a way by the power analytics module 240 in an embodiment may be communicated to a data collector 261.

The power analytics module 240 in an embodiment may also be capable of assessing and adjusting such policies within firmware for one or more hardware components, upon user approval. For example, the power analytics module 240 in an embodiment may determine that an instruction for a network interface device 220 to transceive according to the Bluetooth®, rather than WLAN, WWAN, or in RDP, or reset policies for the network interface device 220 to restrict remote calls, operation as a mirror server, power consumption, data rate, or frequencies be used to limit CO2 emissions. In another example, the power analytics module 240 in an embodiment may determine that an instruction to adjust the usage mode for the display 245 to a lower power consumption mode, such as power reserve mode, or lower resolution mode may be used to limit CO2 emissions. In still another example embodiment, the power analytics module 240 may decrease the periods in which sensing hardware may be operational, such as restricting such periods to when the first client information handling system 250 is in a closed position, an idle or sleep mode, currently moving, or in startup mode. In yet another embodiment, the power analytics module 240 may determine that an instruction to adjust the media capture instructions setting for the camera 247 by decreasing a resolution of captured images or a frequency at which those images are captured, or limiting execution of any processing algorithms that may be applied to those images (e.g., zooming, cropping, background image application, boundary recognition, face recognition, smoothing, etc.) may be used to limit CO2 emissions.

In an embodiment, the power analytics module 240 may also be capable of determining the current versions of drivers for various hardware components (e.g., 220, 242, 243, 244, 245, 246, 247, 248, or 249). In still other embodiments, the power analytics module 240 may further determine power consumed during updates made to various firmware or software applications executing via the hardware processor 242 (e.g., CPU, GPU, or VPU).

As described above, the power analytics module 240 may be in communication with a data collector 261, which may also be in communication with an application analytics module 230. In an embodiment, the application analytics module 230 may monitor and adjust execution of software applications within the operating system (OS) for the first client information handling system 250. The application analytics module 230 in an embodiment may further track which software applications are running or idle (e.g., executing in the background) at various times, and track current versions of software applications and times at which updates to such software applications are performed. In still another example, the application analytics module 230 may determine current usage as a percentage of total capacity for memory 246, time required to process requests to access such memory 246, and identify software applications most frequently accessing such memory 246. In yet another example, the applications analytics module 230 may determine a number of browsing windows engaged in active sessions, and a time of such active engagement. Information gathered by the application analytics module 230 in such an embodiment may be communicated to the data collector 261.

The application analytics module 230 in an embodiment may further direct operation of certain software applications, based on user approval. For example, the application analytics module 230 in an embodiment may determine that an instruction to cap the percentage of total capacity for the hardware processor 242, the memory 246, or the network interface device 222 that may be used by specifically identified software applications, or terminate software applications submitting repeated interrupts to the hardware processor 242 may be used to limit CO2 emissions. As another example, the application analytics module 230 in an embodiment may determine that an instruction to terminate or cap the percentage of total capacity for the hardware processor 242, memory 246, or network interface device 222 that may be used by idle or background applications may be used to limit CO2 emissions. In yet another example, the application analytics module 230 may determine that an instruction to cap the amount of time per day that a browsing software application (e.g., Google® Chrome®, Firefox C)) maintains active sessions, or capping a number of active windows within such browsing software applications may be used to limit CO2 emissions.

As described herein, the data collector module 261 in an embodiment may gather data regarding hardware configuration and power consumption from the power analytics module 240 and data regarding software performance and hardware processor/memory usage from the application analytics module 230. In some embodiments, the data collector may also gather information from an event viewer 265 (e.g., Microsoft® Event Viewer) tracking computing events relating to software, firmware, and hardware in real-time. Such events may include notification of errors relating to various attempted processes at the first client information handling system 250. More specifically, the event viewer 265 in an embodiment may record one or more Windows Hardware Error Architecture (WHEA) events indicating a hardware error. Such WHEA events may be associated with data packets that specifically identify the hardware component (e.g., 220, 242, 243, 244, 245, 246, 247, 248, or 249) producing the error. The data collector 261 may routinely collect information from each of the power analytics module 240, the application analytics module 230 or the event viewer 265 at preset intervals, or may do so upon notification by one of these modules (e.g., 230, 240, or 265) of a specific event, failure, or warning.

Information recorded by the event viewer 265 in an embodiment may be output in the form of a log, while information recorded by the power analytics module 240 or the application analytics module 230 may be output into reports. The format of such a log or report may vary, which may require reformatting of such information into an easily classified, sorted, and searchable format. Thus, the data collector 261 in an embodiment may operate to reformat any received logs or reports into a predetermined data interchange format such as JavaScript Object Notation (JSON), of Extensive Markup Language (XML). Specific examples described herein may use the JSON format for consistency and ease of explanation, but any other type of existing or later developed predetermined data interchange format agreed upon between data sinks and sources may be used in various embodiments.

The data collector 261 in an embodiment may transmit information received at any given time from the power analytics module 240, application analytics module 230, or event viewer 265) and reformatted to a predetermined data interchange format (e.g., JSON) to a data classifier 262. Such a JSON-formatted report or log may be referred to herein as a JSON event. Each JSON event may include any information gathered from the power analytics module 240, application analytics module 230, or event viewer 265 and a time stamp associated with either the time the analytics module report was generated, or the time at which a WHEA (or other known convention for categorizing processing events) error occurred. In some cases, a JSON event may include a single WHEA error (e.g., hardware processor error), or a single notification or warning from an analytics module (e.g., failure of a hardware component such as the fan 243). In other cases, a JSON event may include routinely gathered information such as current configurations or policies for various hardware components (e.g., 220, 242, 243, 244, 245, 246, 247, 248, or 249) or software applications, power consumption of those components over a known monitoring time period, current versions of drivers or software applications, and timestamps for installation of updates to such drivers or software applications. Such information may be illustrated by the following table:

TABLE 1

| | |
|---|---|
| Timestamp | 1544145450 |
| Client Device ID | 456789 |
| Event ID | 123460 |
| Errors, notifications, | Fan operating at 60 W |
| warnings | Fan workload at 90% |
| | Testing application using 90% CPU |
| | Background applications using 90% memory |
| | Browsing application using 90% network |
| | interface device resources |
| | Temperature above 140 degrees F. |
| Location | New Delhi, India |
| Model | Laptop 7400 |
| Hardware Configuration | WLAN network interface device; |
| | WWAN network interface device; |
| | Bluetooth ® network interface device; |
| | 16 GB memory; |
| | X series CPU; |
| | G Series GPU; |
| | 256 GB Solid State Drive (SSD); |
| | 15.6 inch full high definition (HD) organic |
| | light emitting diode (OLED) display; |
| | Fan driver version 14.2; |
| | Webcam Camera type; |
| Hardware Performance | WWAN Interface Device transceived 100 |
| | GB; |
| | Battery efficiency 59%; |
| | Display in High Definition Mode; |
| | Motion Detector Set to Continuous Monitor; |
| | Camera in High Resolution Mode; |
| | System used 16 hours per day; |
| | 200 Watts total power consumption per day; |
| | Internal temperature 142 degrees F.; |
| Software Performance | Operating System 10.2; |
| | Browsing application active eight hours per |
| | day; |
| Usage Patterns | Usage profile hardware testing |

Some or all of the information displayed above within TABLE 1 may be formatted as a JSON incident in an embodiment. Each row of the above table may be formatted as one or more JSON events within the JSON incident in an embodiment. A JSON incident may include a data node identifying an event ID, a source for the event (e.g., power analytics module 240, applications analytics module 230, or event viewer 265), a timestamp for that event, one or more custom flags identifying the errors, notifications, or warnings, and one or more device current states, identifying the software and hardware configurations. Any one of the rows of the JSON incident illustrated directly below may represent a JSON event. For example, such a data node depicting information from TABLE 1, above, may appear in a JSON incident as:

```
{
  “data” :
  {
    “event_id” : 123460,
    “source_ID” : power_analytics_module,
    “timestamp_unixtime_ms” : 1544145450,
    “custom_flags” :
      {
        “fan_workload” : 0.90,
        “testing_application_CPU_usage” : 0.9,
        “background_application_memory_usage” : 0.9,
        “browsing_application_NID_usage” : 0.9,
        “temperature_F” : above_140,
      }
    “device_current_state :
      {
        “NID_1_type” : WLAN,
        “NID_2_type” : WWAN,
        “NID_2_data_transceived” : 100 GB,
        “NID_3_type” : BT,
        “memory_type” : 16_GB,
        “CPU_type” : X_Series,
        “GPU_type” : G_Series,
        “SSD_type” : 256_GB,
        “Display_type” : 15.6_HD_OLED,
        “fan_driver_version” : 14.2,
        “Display_mode” : high_definition,
        “Camera_type” : webcam,
        “Camera_detection_mode” : continuous_monitor,
        “Camera_capture_mode” : high_resolution,
        “temperature_F” : 142,
        “OS_Version” : 10.2,
        “efficiency_battery” : 0.59,
        “usage_time_hours_perday” : 16,
        “fan_power_consumption_watts” : 60,
        “total_power_consumption_watts_perday” : 200,
        “active_browsing_hours_perday” : 15,
        “usage_profile” : hardware_testing,
      }
  }
```

The example given above in TABLE 1 and the corresponding above JSON incident may further include any number of other errors, notifications, or warnings, hardware configurations, software performance analytics, or descriptions of policies in place for hardware or software at the client information handling system 250, as monitored by either the power analytics module 240 or the application analytics module 230. Some JSON events in an embodiment may indicate a hardware failure, such as a JSON event named “WHEA_error,” having a value of fan, indicating a failure at the fan. In embodiments where a JSON event indicating a hardware error identifying by the systems internal health assessor appear, the JSON incident may comprise one or more operational telemetry measurements for an information handling system. Upon reformatting of information in an embodiment, the data collector 261 may transmit the JSON incident comprising the operational telemetry measurements to the data classifier 262. In an embodiment, the data classifier 262 may operate to analyze the contents of the JSON incident comprising the operational telemetry measurements, to classify the type of JSON events included therewithin, and to edit the JSON incident to generate a second JSON incident that includes that classification type.

Classification types may be preset according to instructions received by the recommendation agent 290 from the communication agent 281. Such classification types may assist the communication agent 281 and systems internal health assessor 283 in determining when a hardware failure impacting CO2 emissions state for the client information handling system 250 has occurred, or will occur in the immediate future, as described in greater detail below. In example embodiments, classification types, such as software resource use, hardware configuration, or driver performance, may be preset and available for use in classifying JSON incidents received from the data collector 261.

Incident classifications in an embodiment may be associated with one or more previously identified event values. For example, an incident classification for “workload,” identifying relatively high workloads that may result in various hardware component failures in an embodiment may be associated by the device refurbishment CO2 emissions minimization system 280 with JSON events titled “fan_workload” having a value exceeding 85%. In another example, an incident classification for “Config,” identifying a hardware configuration or policy that may result in various hardware component failures in an embodiment may be associated with JSON events titled “Config,” having a value such as “active_browsing_hours_perday” having a value above 10, “server_mirroring” having a value “ON,” “remote_desktop_protocol” having a value “ON,” “remote_processor_calls” having a value “ALLOW,” “full_power_mode” (e.g., indicating full power supplied to the monitor), “active_sensing_mode” (e.g., indicating sensing hardware components set to remain on), “High_Definition_Mode” (e.g., indicating GPU or monitor set to display in high definition). In yet another example, an incident classification for “app_usage,” identifying relatively intensive usage of software applications that may result in various hardware component failures in an embodiment may be associated with JSON events titled “App_usage” having a value exceeding 85%. In still another example, an incident classification for “driver performance,” identifying poor or inefficient driver performance (e.g., as indicated by a percentage of calls to that driver resulting in an error over a preset time period) that may result in various hardware component failures in an embodiment may be associated with JSON events titled “driver_perf” having a value exceeding 50%. In yet another example, an incident classification for “background_usage,” identifying relatively intensive usage of software applications operating in idle mode or in the background that may result in various hardware component failures in an embodiment may be associated with JSON events titled “background_usage” having a value exceeding 85%. In still another example, an incident classification for “temperature,” identifying internal temperatures (e.g., interior to a chassis surrounding the client information handling system) above a preset maximum internal temperature (e.g., 140 degrees Fahrenheit) in an embodiment be associated with JSON events titled “temperature_F” having a value above 140. Any numerical or percentage maximum application usage threshold values preset as described directly above may be set to any number between one and one hundred in various embodiments described herein.

In an example embodiment, the data classifier 262 in an embodiment may analyze the JSON incident comprising operational telemetry measurements described above to identify whether any of the JSON events and values associated with preset incident classifiers appear within the JSON incident. For example, the data classifier 262 in an embodiment may determine the JSON incident comprising operational telemetry measurements described above includes the JSON event named “fan_workload,” having a value of 0.90, or 90%, which is greater than the preset maximum fan workload of 85%. In such an embodiment, the data classifier 262 may determine these JSON events are associated with the preset incident classifier “workload,” and may append this classification to the end of the JSON incident comprising operational telemetry measurements to generate a classified JSON incident comprising operational telemetry measurements:

{
“incident_class” : Workload,
}

In other embodiments in which the data classifier 262 identifies a JSON event “fan_driver_install_time_mins” having a value greater than 60 minutes, or some other preset maximum installation time, or a JSON event “unsuccessful_driver_install_attempts,” the data classifier 262 may determine these JSON events and values are associated with the preset incident classifier “driver_perf.” In another aspect of such embodiments, the data classifier 262 may identify JSON events such as “active_browsing_hours_perday” having a value above 10, “server_mirroring” having a value “ON,” “remote_desktop_protocol” having a value “ON,” “remote_processor_calls” having a value “ALLOW.” The data classifier 262 in such an embodiment may associate any of these JSON events and values with the classification “Config.”. In still another embodiment in which the data classifier 262 identifies a JSON event “temperature_F” having a value above 140, the data classifier 262 may determine this JSON event and value is associated with the preset incident classifier “temperature.” In yet another embodiment in which the data classifier 262 identifies a JSON event “humidity_percent” having a value above 60, the data classifier 262 may determine this JSON event and value is associated with the preset incident classifier “humidity” and append that classification to the JSON incident to generate a classified JSON incident comprising operational telemetry measurements such as:

```
  }
  incident_class” : Workload,
  “incident_class” : Temperature,
  “incident_class” : Humidity,
  “incident_class” : Driver_perf,
  “incident_class” : Config,
}
```

The classified JSON incident comprising operational telemetry in an embodiment may be transmitted to the device index mapper 263, which may operate to associate the classified JSON incident with a device ID and device model for the first client information handling system 250. Such a device ID in an embodiment may be one of several device IDs for a plurality of information handling systems (e.g., including the first and second client information handling systems 250 and 270) stored at the UEM platform 200. In some embodiments, the device index mapper 263 may also retrieve a location for the first client information handling system 250 from the location mapper 264 or the GPS unit 248. In some cases, the location mapper 264 may represent the location of the first client information handling system 250 with reference to its location within a campus of an enterprise. More specifically, the first client information handling system 250 may be located on a specific floor of a specific building. The device index mapper 263 in an embodiment may then edit the classified JSON incident comprising operational telemetry measurements to generate an indexed and classified JSON incident comprising operational telemetry measurements that includes this information, such as shown directly below, which is then transmitted to the recommendation agent 290:

```
{
  “data” :
  {
    “event_id” : 123460,
    “source_ID” : power_analytics_module,
    “timestamp_unixtime_ms” : 1544145450,
    “client_device_ID” : 456789,
    “client_device_model” : Laptop_7400,
    “location” : New Delhi, India,
    “custom_flags” :
      {
        “fan_workload” : 0.90,
        “testing_application_CPU_usage” : 0.9,
        “background_application_memory_usage” : 0.9,
        “browsing_application_NID_usage” : 0.9,
        “temperature_F” : above_140,
      }
    “device_current_state :
      }
        “NID_1_type” : WLAN,
        “NID_2_type” : WWAN,
        “NID_2_data_transceived” : 100 GB,
        “NID_3_type” : BT,
        “memory_type” : 16_GB,
        “CPU_type” : X_Series,
        “GPU_type” : G_Series,
        “SSD_type” : 256_GB,
        “Display_type” : 15.6_HD_OLED,
        “fan_driver_version” : 14.2,
        “Display_mode” : high_definition,
        “Camera_type” : webcam,
        “Camera_detection_mode” : continuous_monitor,
        “Camera_capture_mode” : high_resolution,
        “temperature_F” : 142
        “OS_Version” : 10.2,
        “efficiency_battery” : 0.59,
        “usage_time_hours_perday” : 16,
        “fan_power_consumption_watts” : 60,
        “total_power_consumption_watts_perday” : 200,
        “active_browsing_hours_perday” : 15,
        “usage_profile” : hardware_testing,
      }
  }
  “incident_class” : Workload,
  “incident_class” : Temperature,
}
```

As described herein, the UEM platform 200 in an embodiment may gather JSON incidents, like the one described directly above, routinely from a plurality of client information handling systems operating under different environmental conditions and usage patterns. For example, the UEM platform 200 in an embodiment may receive the JSON incident described directly below from the second client information handling system 270, operating in Paris, France, and having a different usage profile (e.g., personal) than the usage profile (e.g., hardware testing) given for the first client information handling system 250 operating in New Delhi, India.

```
{
  “data” :
  {
    “event_id” : 123461,
    “source_ID” : power_analytics_module,
    “timestamp_unixtime_ms” : 1544145451,
    “client_device_ID” : 987654,
    “client_device_model” : Laptop_5400,
    “location” : Paris, France,
    “custom_flags” :
      {
        “videoconferencing_application_NID_usage” : 0.9,
      }
    “device_current_state :
      {
        “NID_1_type” : WLAN,
        “NID_2_type” : WWAN,
        “NID_2_data_transceived” : 100 GB,
        “NID_3_type” : BT,
        “memory_type” : 8_GB,
        “CPU_type” : A_Series,
        “GPU_type” : B_Series,
        “SSD_type” : 256_GB,
        “Display_typE” : 15.6_HD_OLED,
        “Camera_type” : webcam,
        “OS_Version” : 10.2,
        “efficiency_battery” : 0.25,
        “usage_time_hours_perday” : 8,
        “fan_power_consumption_watts” : 20,
        “total_power_consumption_watts_perday” : 60,
        “active_browsing_hours_perday” : 3,
        “usage_profile” : personal,
      }
  }
  “incident_class” : Config
}
```

The recommendation agent 290 in an embodiment may determine a CO2 emissions value for the client information handling system 250 based on the classified and indexed JSON incident received from the device index mapper 263. This CO2 emissions value determination may be made based on the location of the device, the power consumed by each of the hardware components, the usage time for such power consumption, and the efficiency of the battery, as shown in the indexed and classified JSON incident.

The location of the client information handling system may define an estimated amount of CO2 (in pounds per kWh) emitted during generation of the power consumed by the client information handling system. Carbon footprint for a client information handling system (e.g., 250 or 270) in an embodiment may be based on the power consumed by the client information handling system (e.g., 250 or 270), the duration of such consumption, and a location CO2 emissions rate describing the amount of CO2 or other GHGs emitted during generation of each Watt of power consumed by the client information handling system (e.g., 250 or 270). In embodiments, the recommendation agent 290 may communicate with the CO2 optimization engine 285 or telemetry 282 to determine such a location CO2 emissions rate for the client information handling systems 250 based on the location given within an indexed and classified JSON incident (e.g., as shown directly above) and stored in telemetry 282. For example, the recommendation agent 290 may communicate with the CO2 optimization engine 285 or telemetry 282 to determine the location CO2 emissions rate describing the amount of CO2 of other GHGs emitted during generation of each Watt of power consumed by the client information handling system 250 in New Delhi, India (e.g., the location of the client information handling system 250 as shown in the indexed and classified JSON incident) to be 1.82 pounds CO2 per kWh.

In an example embodiment when the client information handling system 250 has just been initially operated (and is thus assumed to be operating at peak efficiency), the CO2 emissions value may be determined using the equation below to determine the CO2 emissions value for the client information handling system 250 operating in Paris, France, where the location CO2 emissions rate is 1.82 pounds CO2 per kWh, the power consumed is 200 Watts over a usage time of 16 hours at a battery efficiency of 59% is equivalent to 9.87 pounds CO2 per day:

$$CO 2 Emissions Value = \frac{location CO 2 emissions rate * Power Consumed * Usage Time}{Battery Efficiency}$$

The recommendation agent in an embodiment may perform this determination of CO2 emissions value for each indexed and classified JSON incident it receives from the device index mapper 263 over the CO2 emissions state determination training period. Following such a determination, the recommendation agent 290 may append one or more JSON events indicating the CO2 emissions value within the indexed and classified JSON incident most recently received from the device index mapper 263 and upon which such a determination was made.

As described herein, the recommendation agent 290 executing on hardware processing resources at a client information handling system 250 in an embodiment may set goals for capping CO2 emissions due to operation of the client information handling system 250 that takes the age of the device and its components into account. In an embodiment, the life cycle of each client information handling system (e.g., 250) may be divided into three states. These states include a first, peak-health training state, immediately following initial purchase and use of the device, a monitoring second state in which the client information handling system consistently meets the goal for capping CO2 emissions, and a non-eco-friendly third state in which inefficient operation of the device unrelated to age causes the client information handling system to fail to meet that goal. Each of the threshold CO2 emissions values defining these states may be unique to each client information handling system and may be established to take into account the age of each device. For example, the first state may be defined by a maximum value of pounds of CO2 emitted per hour measured during a preset three or six month period following initial operation of the client information handling system. During this first state, it is assumed that the client information handling system is working at peak efficiency. In other words, it is assumed that the client information handling system is not experiencing efficiency loss due to age or due to inefficient use of the device. For example, in an embodiment in which the recommendation agent 290 uses the indexed and classified JSON incident shown above to determine the maximum recorded CO2 emissions value during the training period, the recommendation agent 290 may define the maximum CO2 emissions value for the training period to be 2.184 pounds CO2 per day. This first state threshold maximum value of pounds of CO2 emitted per hour may provide an initial benchmark against which future efficiency of the client information handling system may be measured.

As described above, some decrease in operational efficiency at each client information handling system is unavoidable due to wear and tear of components, such as, for example, the battery. Thus, the CO2 emitted per hour is expected to increase over time to an adjustable benchmark, even when the client device is being used as efficiently as possible, due to decreased efficiency of the battery as it ages. In other words, even if the updating and execution of software and firmware and power consumption of various components are optimized for minimizing CO2 emissions, increases in CO2 emissions during operation of the client information handling system will still occur. The recommendation agent 290 in embodiments of the present disclosure differentiates such unavoidable increases in CO2 emissions due to aging from further increases in CO2 emissions due to avoidable inefficient usage of the client information handling system (e.g., due to failure to perform updates, non-optimized execution of software or firmware, or non-eco-friendly power consumption by hardware components).

The recommendation agent 290 may determine a minimum allowable battery efficiency prior to prompting replacement of the battery in an embodiment. These values may be used below to define the boundary between CO2 emissions state two and state three. The recommendation agent 290 in an example embodiment may define this minimum allowable battery efficiency at 25%. In such an example embodiment, the recommendation agent 290 anticipates that the battery efficiency may degrade down to 25% before the battery will be replaced.

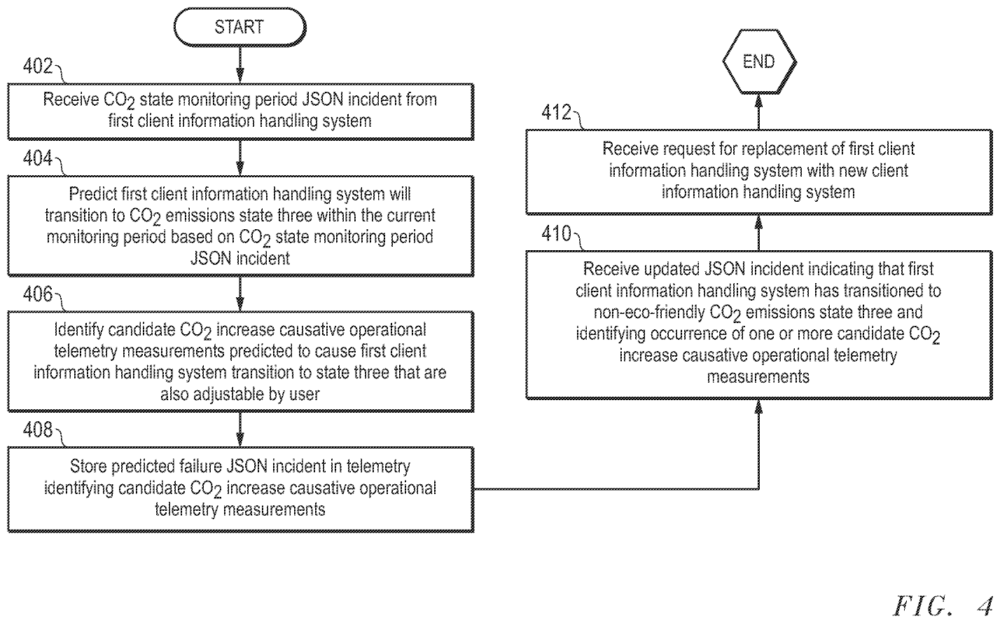

The recommendation agent 290 in an embodiment may determine a CO2 emissions state three transition threshold value based on the state two transition threshold value and a minimum allowable battery efficiency, as described in greater detail below with respect to FIG. 4. The recommendation agent 290 may determine a minimum allowable battery efficiency prior to prompting replacement of the battery in an embodiment. These values may be used below to define the boundary between CO2 emissions state two and state three. As described herein, some decrease in operational efficiency at each client information handling system (e.g., 250) is unavoidable due to wear and tear of components, such as, for example, the battery 244. Thus, the CO2 emitted per hour is expected to increase over time, even when the client device 250 is being used as efficiently as possible, due to decreased efficiency of the battery 244 as it ages. The CO2 emissions state transition determination system 290 in an embodiment differentiates such unavoidable increases in CO2 emissions due to aging from further increases in CO2 emissions due to avoidable inefficient usage of the client information handling system 250 (e.g., due to failure to perform updates, non-optimized execution of software or firmware, or non-eco-friendly power consumption by hardware components). For example, the recommendation agent 290 in an embodiment may determine a CO2 emissions state three transition threshold value of 8.736 pounds CO2 per kWh by dividing the CO2 emissions state two transition threshold by the minimum allowable battery efficiency. This maximum CO2 emissions value defining the second state in embodiments may be referred to herein as a non-eco-friendly state transition threshold value. When operation of the client information handling system 250 causes emission of CO2 beyond this non-eco-friendly state transition threshold value, the client information handling system 250 may pass from the second state to the third, non-eco-friendly state in which inefficient operation of the device unrelated to age causes increased CO2 emissions. In such a way, the recommendation agent 290 may estimate CO2 emissions for optimally efficient usage of the client information handling system 250 in state two, given the unavoidable drop in efficiency of its battery.

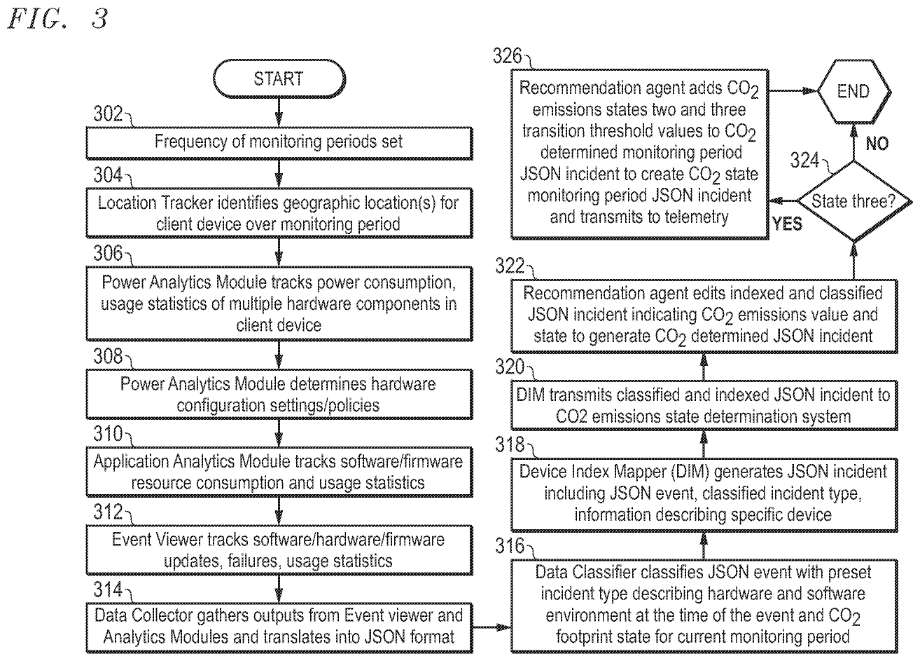

The recommendation agent 290 may initiate a CO2 emissions state monitoring period following determination of the CO2 emissions states two and three transition threshold values described directly above. During this monitoring period, the recommendation agent 290 may routinely generate CO2 determined monitoring period JSON incidents (similarly to the method used to generate a CO2 determined training period JSON incident described below with respect to FIG. 3) during a routine period of monitoring, and append the determined CO2 emissions value, CO2 emissions state two transition threshold value, and CO2 emissions state three transition threshold value to generate CO2 state monitoring period JSON incidents.

A data segregator 266 of the client information handling system 250 in an example embodiment may determine whether the client information handling system is operating within the CO2 emissions state three and may include a usage profile for the client information handling system 250 within the CO2 state monitoring period JSON incident during each monitoring period described directly above. The data segregator 266 in an embodiment may operate to narrow the number of CO2 state monitoring period JSON incidents transmitted to the device refurbishment CO2 emissions minimization system 280 at the Unified Endpoint Management (UEM) platform 200 and to assist execution of code instructions of the device refurbishment CO2 emissions minimization system 280 to sort CO2 state monitoring period JSON incidents according to usage profiles.

As described herein, execution of code instructions for the device refurbishment CO2 emissions minimization system 280 via hardware processing resources in an embodiment may predict the cause of an information handling system (e.g., 250 or 270) operating in CO2 emissions state three (non-eco-friendly state). Because the device refurbishment CO2 emissions minimization system 280 in such an embodiment only analyzes causes of client information handling systems (e.g., 250 or 270) currently operating within the CO2 emissions third state, only CO2 state monitoring period JSON incidents from those information handling systems (e.g., 250 or 270) currently operating in the CO2 emissions third state may be transmitted to the device refurbishment CO2 emissions minimization system 280.

As also described herein, in some embodiments, a separate neural network may be trained for each usage profile identified by the data segregator 266 within the CO2 state monitoring period JSON incidents for the plurality of client information handling systems. For example, such usage profiles may specify the type of activities for which the client information handling system (e.g., 250 or 270) has been purchased. More specifically, example usage profiles may identify the client information handling system 250 as a corporate device used primarily for presentations, accounting, or enterprise-wide communications, or as a testing device (e.g., as indicated by the JSON incident described above for client information handling system 250 having a JSON event named “usage profile” and a value of “hardware testing”) used for operational testing of various peripherals or hardware components. In another example, usage profiles may identify the client information handling system 250 as a code-compiling or software application development machine, a device used primarily as a home computer or personal computer, or a device intended for use as a gaming platform. In an example embodiment, this information may be determined based on user input via a GUI during initial startup of the client information handling system (e.g., 250) following its purchase. The data segregator 266 in an example embodiment may include a JSON event named “usage profile” having a value of “corporate,” or any of the other above-described usage profiles (e.g., “hardware testing,” “personal,” or “code compiling”), such as for client information handling systems executing software applications used for corporate administrative functions or other contemplated usage profiles, or in the case of determining replacement options using contrasting usage profiles within the CO2 state monitoring period JSON incident. Any client usage profile categories may be utilized for various client information handling systems monitored by the UEM platform such that those with similar usage profiles may be used as inputs and as a basis for comparison. These CO2 state monitoring period JSON incidents may then be transmitted to the CO2 state transition prediction system 280 of the UEM platform 200.

The CO2 state transition prediction system 280 in an embodiment may operate to identify a cause when a client information handling system (e.g., 250) has transitioned from CO2 emissions state two to CO2 emissions state three during a previous monitoring period. As described herein, a cloud-based device refurbishment CO2 emissions minimization system 280 may orchestrate, by generating instructions for refurbishment and replacement of the client information handling system (e.g., 250) that has crossed into the non-eco-friendly CO2 emissions state three during use by a first user to transfer to a second user whose usage profile or geographic location may allow use of the first client information handling system by such a second user to place the first client information handling system within the eco-friendly CO2 emissions state one or two again and extend its useful life. In other embodiments, the client information handling system (e.g., 250) may be refurbished and resold to the second user.

The communication agent 281 operating at the UEM platform 200 in an embodiment may receive and store in telemetry CO2 state monitoring period JSON incidents from a plurality of client information handling systems (e.g., 250 and 270) over a plurality of monitoring periods. In some embodiments, a systems internal health assessor (SIHA) 283 operating at the Unified Endpoint Management (UEM) platform 200 may identify one or more CO2 state monitoring period JSON incidents indicating hardware failure. For example, the SIHA 283 operating at the UEM platform 200 in an embodiment may identify one or more CO2 state monitoring period JSON incidents received from the client information handling system (e.g., 250 or 270) indicating hardware failure at those devices.

The CO2 optimization engine 285 in an embodiment may use one or more neural networks trained to model relationships between changes in CO2 emissions values over a most recent monitoring period and changes in telemetry measurements in CO2 state monitoring period JSON incidents received from a plurality of client devices over the monitoring period immediately preceding the most recent monitoring period. The CO2 optimization engine 285 in an embodiment may receive and input into the crowd-source trained neural network a CO2 state monitoring period JSON incident from a first client information handling system (e.g., 250) in order to predict the CO2 emissions state in which the first client information handling system 250 will operate during the current monitoring period.

The execution of code instructions of the CO2 optimization engine 285 in an embodiment may be used to determine whether the output from the neural network 286 indicates a transition from state two to the non-eco-friendly state three or vice-versa when assessing if a replacement transfer to a second user may bring the client information handling system back to an eco-friendly CO2 emissions state. This determination is based on the input of the CO2 state monitoring period JSON incident. If the neural network 286 output indicates such a CO2 emissions state transition, this may indicate a high likelihood that the client information handling system 250 will transition from state three to state two if a replacement transfer is made. In such an embodiment, the code instructions of the CO2 optimization engine 285 executing on hardware processing resources of the UEM platform 200 in an embodiment may identify one or more candidate CO2 increase causative operational telemetry measurements that may have caused the client information handling system to have transitioned from state two to state three in the first place. This identification may include identifying a plurality of remediation user instructions for adjusting operation of the client information handling system 250 resulting in various values of user-adjustable operational telemetry measurements identified within the received CO2 state monitoring period JSON incident to limit the transition to the non-eco-friendly state. The remediation instruction may be rejected by a first user for various reasons, but may be acceptable for the replacement transfer of the refurbished client information handling system to a second user. For example, in an embodiment in which the CO₂ state monitoring period JSON incident identifies to the CO2 optimization engine 285 an inefficient operation as a candidate client device operation cause for the predicted transition. Other example candidate CO2 increase causative operational telemetry measurements are described in greater detail below with respect to FIG. 4. As also described below with respect to FIG. 4, the CO2 optimization engine 285 in an embodiment may store a predicted failure JSON incident within telemetry 282 identifying the most recently received CO2 state monitoring period JSON incident input into the neural network 286 to cause the predicted transition to the non-eco-friendly CO2 emissions state three and each of the identified candidate CO2 increase causative operational telemetry measurements.

As described in greater detail below with respect to FIG. 4, the client information handling system 250 in an embodiment may ultimately transition to the non-eco-friendly CO2 emissions state three, as predicted by the CO2 optimization engine 285 and neural network 286. This may indicate that the CO2 increase causative operational telemetry measurements identified within the predicted failure JSON incident stored in telemetry 282 for the first client information handling system 250 may have caused the client information handling system 250 to pass into the non-eco-friendly CO2 emissions state three with its CO2 increase causative operational telemetry as predicted. In an embodiment, the user of the first client information handling system 250 whose usage pattern, workload, or geographic location-based ambient temperature or humidity have resulted in the transition to the non-eco-friendly state three may return the first client information handling system 250 to a refurbished device hub 231 within the enterprise management system 235. At that point, the device refurbishment CO2 emissions minimization system 280 in an embodiment may orchestrate, by generating instructions for refurbishment or replacement or resale of the first client information handling system 250 and transfer to another user whose usage profile, workload, or geographic location may allow the first client information handling system 250 to operate within the eco-friendly CO2 emissions state one or two, without replacement of hardware components, or alteration of the second user's usage patterns or workload.

FIG. 3 is a flow diagram illustrating a method of gathering power and application analytics for diagnosing cause of increased CO2 emissions for a client information handling system that may be refurbished for replacement according to an embodiment of the present disclosure. As described herein, a recommendation agent in various embodiments may determine a first, optimal efficiency CO2 emissions state, a second monitoring period CO2 emissions state, and a third non-eco-friendly CO2 emissions state for an information handling system based on gathered operational telemetry measurements for the information handling system over a training period. As also described herein, a device refurbishment CO2 emissions minimization system in various embodiments may use a neural network trained on crowd-sourced operational telemetry measurements from a plurality of client information handling systems to model a relationship between operational telemetry measurements and CO2 emissions states. FIG. 3 describes the method of gathering these operational telemetry measurements from a plurality of client information handling systems in the form of JSON incidents in an example embodiment.

At block 302, a user of the client information handling system or IT professional within an enterprise management system in an embodiment may set a monitoring period for monitoring CO2 emissions states at the information handling system. For example, in an embodiment described with reference to FIG. 2, the data collector 261 in an embodiment may gather data regarding hardware configuration and power consumption from the power analytics module 240 and data regarding software performance and hardware processor usage from the application analytics module 230 at preset intervals. For example, such a preset interval may be set to a default monitoring period value (e.g., one hour, one day, one week, one month, or other), or may be set by the user of the first client information handling system 200 via the graphical user interface (GUI) 290.

Proceeding to block 304, a location tracking in an embodiment may identify a geographic location for the client information handling system over the user-specified monitoring period. For example, the location sensing unit 248 in an embodiment may determine a geographic location (e.g., zip code, GPS coordinates, city, state, country) in which the first client information handling system 250 is operating.

At block 306, the power analytics module may track power consumption of multiple hardware components in the client information handling system in an embodiment. For example, the power analytics module 240 in an embodiment may monitor power consumption by each of the various hardware components (e.g., 220, 242, 243, 244, 245, 246, 247, 248, or 249) in an embodiment. In some embodiments, such hardware power consumption may be attributed to specific software applications. For example, the power analytics module 240 in an embodiment may determine current usage of hardware processing resources by software applications as a percentage of total capacity for the hardware processor 242 (e.g., central processing unit (CPU), graphics processing unit (GPU), or visual processing unit (VPU) or another hardware processing resource). In still another example, the power analytics module may determine current usage of memory resources by software applications as a percentage of total capacity for memory 246, time required to process requests to access such memory 246, and identify software applications most frequently accessing such memory 246. In yet another example, the power analytics module 240 in an embodiment may determine a current usage of the display by software applications as a percentage of display time in which GUI for a specific software application is visible, and a usage mode for the display 245, such as day mode, night mode, power reserve mode, or gaming mode (e.g., high-resolution). In another example, the power analytics module 240 in an embodiment may determine current usage of network interface device resources by software applications as a percentage of total capacity for the network interface device 220 to transceive data (e.g., percentage of total available throughput used). All information accessed in such a way by the power analytics module 240 in an embodiment may be communicated to the data collector 261.

The power analytics module in an embodiment may determine hardware configurations, settings, or policies at block 308. For example, the power analytics module 240 may access firmware for hardware components (e.g., 220, 242, 243, 244, 245, 246, 247, 248, or 249) to determine policies or settings for those components at the time of power measurements made at block 306. More specifically, the power analytics module 240 in an embodiment may determine whether a network interface device 220 is transceiving according to WLAN, WWAN, Bluetooth®, Remote Desktop Protocol (RDP), or Near Field Communication (NFC) standards, as well as policies setting a preference for one type of standard over another, or restrictions on operation of the first client information handling system 250 as a mirror server, on allowing remote users to make calls to the hardware processor 242, or on power consumption, data rate, or frequencies used by the network interface device 220. In another example, the power analytics module 240 in an embodiment may determine current usage of hardware processing resources by software applications as a percentage of total capacity for the hardware processor 242 (e.g., central processing unit (CPU), graphics processing unit (GPU), or visual processing unit (VPU)). In yet another example, the power analytics module 240 in an embodiment may determine a current usage mode for the display 245, such as day mode, night mode, power reserve mode, or gaming mode (e.g., high-resolution). In still another example embodiment, the power analytics module 240 may determine policies controlling the periods in which sensing hardware may be operational. More specifically, the power analytics module 240 in an embodiment may determine whether the peripheral device 249, location sensing device (e.g., GPS unit) 248, or camera 247 are set to remain on at all times, to operate only when a laptop or mobile information handling system is in a certain position (e.g., closed or open), to operate when a mobile device is currently moving, or to operate only when a user is actively executing software applications or certain software applications. In yet another embodiment, the power analytics module 240 may determine the media capture instructions setting for the camera 247, indicating a resolution of captured images, a frequency at which those images are captured, and any processing algorithms that may be applied to those images (e.g., zooming, cropping, background image application, boundary recognition, face recognition, smoothing, etc.). All information accessed in such a way by the power analytics module 240 in an embodiment may be communicated to a data collector 261.

At block 310, a hardware processor executing the application analytics module may track software or firmware updates in an embodiment. For example, in an embodiment, the application analytics module 230 may monitor execution of software applications within the operating system (OS) for the first client information handling system 200. The application analytics module 230 in an embodiment may further track which software applications are running or idle (e.g., executing in the background) at various times, track CPU utilization, and track current versions of software applications and times at which updates to such software applications are performed. All information accessed in such a way by the application analytics module 230 in an embodiment may be communicated to the data collector 261.

The event viewer may track failed attempts at firmware or software updates in an embodiment at block 312. For example, the data collector 261 may also gather information from an event viewer 265 (e.g., Microsoft® Event Viewer) tracking computing events relating to software, firmware, and hardware in real-time. Such events may include notification of errors relating to various attempted processes at the first client information handling system 250. More specifically, the event viewer 265 in an embodiment may record one or more Windows Hardware Error Architecture (WHEA) events indicating a hardware error, a failed attempt at firmware or software updating, or an unusually high consumption of power by hardware components, or identifying the driver or software application associated with a failed update. Such WHEA events may be associated with data packets that specifically identify the hardware component (e.g., 220, 242, 243, 244, 245, 246, 247, 248, or 249) producing the error or consuming the unusually high power levels.

At block 314, a data collector of a client information handling system in an embodiment may gather event log data, or reports from analytics engines such as hardware analytics applications or software analytics applications, and translate these logs or reports into a predetermined data interchange format such as JavaScript Object Notation (JSON), Extensive Markup Language (XML), or Yet Another Markup Language (YAML). Any format may be used, but JSON is discussed herein by way of an example embodiment. For example, in an embodiment described with reference to FIG. 2, above, the hardware processor executing code instructions of the data collector 261 may gather reports from the power analytics module 240 and the application analytics module 230 and event logs from the event viewer 265. The data collector 261 in such an embodiment may further translate these reports and logs into JSON incidents for later parsing, searching, and editing by various components of the first client information handling system 250 and the device refurbishment CO2 emissions minimization system 280. For example, the data collector 261 may generate the following JSON incident based on the information gathered and stored in Table 1, above:

```
{
  “data” :
  {
    “event_id” : 123460,
    “source_ID” : power_analytics_module,
    “timestamp_unixtime_ms” : 1544145450,
    “custom_flags” :
      {
        “fan_workload” : 0.90,
        “testing_application_CPU_usage” : 0.9,
        “background_application_memory_usage” : 0.9,
        “browsing_application_NID_usage” : 0.9,
        “temperature_F” : above_140,
      }
    “device_current_state :
      {
        “NID_1_type” : WLAN,
        “NID_2_type” : WWAN,
        “NID_2_data_transceived” : 100 GB,
        “NID_3_type” : BT,
        “memory_type” : 16_GB,
        “CPU_type” : X_Series,
        “GPU_type” : G_Series,
        “SSD_type” : 256_GB,
        “Display_type” : 15.6_HD_OLED,
        “fan driver_version” : 14.2,
        “Display_mode” : high_definition,
        “Camera_type” : webcam,
        “Camera_detection_mode” : continuous_monitor,
        “Camera_capture_mode” : high_resolution,
        “temperature_F” : 142,
        “OS_Version” : 10.2,
        “efficiency_battery” : 0.59,
        “usage_time_hours_perday” : 16,
        “fan_power_consumption_watts” : 60,
        “total_power_consumption_watts_perday” : 200,
        “active_browsing_hours_perday” : 15,
        “usage_profile” : hardware_testing,
      }
  }
```

At block 316, the data classifier in an embodiment may classify objects within the gathered JSON event with preset incident types describing heat measurements, hardware component failures, or software application execution and usage for the client information handling system at the time of the event. For example, the data classifier 262 in an embodiment may edit the JSON incident created at block 314 by adding an incident classifier. More specifically, the data classifier 262 in an embodiment may analyze the JSON incident comprising operational telemetry measurements generated at block 314 to identify whether any of the JSON events and values associated with preset incident classifiers appear within the JSON incident.

For example, the hardware processor executing the data classifier 262 in an embodiment may determine the JSON incident comprising operational telemetry measurements described above includes the JSON event named “fan_workload,” having a value of 0.90, or 90%, which is greater than the preset maximum fan_workload of 85%. In other embodiments in which the data classifier 262 identifies a JSON event “fan_driver_install_time_mins” having a value greater than 60 minutes, or some other preset maximum installation time, or a JSON event “unsuccessful_driver_install_attempts,” the data classifier 262 may determine these JSON events and values are associated with the preset incident classifier “driver_perf.” In another aspect of such embodiments, the data classifier 262 may identify JSON events such as “active_browsing_hours_perday” having a value above 10, “server_mirroring” having a value “ON,” “remote_desktop_protocol” having a value “ON,” “remote_processor_calls” having a value “ALLOW.” In another aspect of an embodiment, the data classifier 262 may identifies a JSON event “temperature_F” having a value above 140 and associated the JSON incident with the preset incident classifier “temperature.” In still another aspect of an embodiment, the data classifier 262 may identifies a JSON event “humidity percentage” having a value above 60 and associated the JSON incident with the preset incident classifier “humidity” and append that classification to the JSON incident to generate a classified JSON incident comprising operational telemetry measurements such as:

```
  }
  “incident_class” : Workload,
  “incident_class” : Temperature,
  “incident_class” : Humidity
  “incident_class” : Driver_perf,
  “incident_class” : Config,
}
```

The hardware processor may execute code instructions of the device index mapper in an embodiment to generate a classified and indexed JSON incident including one or more JSON events and classified incident types at block 318. For example, the device index mapper (DIM) 263 in an embodiment may associate the classified JSON incident comprising operational telemetry measurements with a device ID and device model for the first client information handling system 200. Such a device ID in an embodiment may be one of several device IDs for a plurality of information handling systems (e.g., including the first and second client information handling systems 250 and 270) stored at the device refurbishment CO2 emissions minimization system 280. The device index mapper 263 in an embodiment may then edit the classified JSON incident comprising operational telemetry measurements to generate an indexed and classified JSON incident that includes this information:

```
{
  “data” :
  {
    “event_id” : 123460,
    “source_ID” : power_analytics_module,
    “timestamp_unixtime_ms” : 1544145450,
    “client_device_ID” : 456789,
    “client_device_model” : Laptop_7400,
    “location” : New Delhi, India,
    “custom_flags” :
      {
        “fan_workload” : 0.90,
        “testing_application_CPU_usage” : 0.9,
        “background_application_memory_usage” : 0.9,
        “browsing_application_NID_usage” : 0.9,
        “temperature_F” : above_140,
      }
    “device_current_state :
      {
        “NID_1_type” : WLAN,
        “NID_2_type” : WWAN,
        “NID_2_data_transceived” : 100 GB,
        “NID_3_type” : BT,
        “memory_type” : 16_GB,
        “CPU_type” : X_Series,
        “GPU_type” : G_Series,
        “SSD_type” : 256_GB,
        “Display_type” : 15.6_HD_OLED,
        “fan_driver_version” : 14.2,
        “Display_mode” : high_definition,
        “Camera_type” : webcam,
        “Camera_detection_mode” : continuous_monitor,
        “Camera_capture_mode” : high_resolution,
        “temperature_F” : 142
        “OS_Version” : 10.2,
        “efficiency_battery” : 0.59,
        “usage_time_hours_perday” : 16,
        “fan_power_consumption_watts” : 60,
        “total_power_consumption_watts_perday” : 200,
        “active_browsing_hours_perday” : 15,
        “usage_profile” : hardware_testing,
      }
  }
  “incident_class” : Workload,
  “incident_class” : Temperature,
}
```

At block 320, the device index mapper may transmit the JSON incident generated at block 318 to the recommendation agent of the client information handling system in an embodiment. As described herein, the recommendation agent 290 in an embodiment may determine an amount of CO2 emitted due to operation of the client information handling system 250 and define three CO2 emissions states in which the client information handling system 250 may operate during its life cycle. These states may include a first, optimal emissions state, a second monitoring period state, and a third, non-eco-friendly state.

The recommendation agent in an embodiment may edit the indexed and classified JSON incident to include a CO2 emissions value and CO2 emissions state for the current CO2 emissions status of the client information handling system at block 322. The recommendation agent 290 in an embodiment may first determine a CO2 emissions value for the client information handling system 250 based on the classified and indexed JSON incident received from the device index mapper 263. This CO2 emissions value determination may be made based on the location of the device, the power consumed by each of the hardware components, the usage time for such power consumption, and the efficiency of the battery, as shown in the indexed and classified JSON incident.

The location of the client information handling system may define an estimated amount of CO2 (in pounds per kWh) emitted during generation of the power consumed by the client information handling system. Carbon footprint for a client information handling system (e.g., 250 or 270) in an embodiment may be based on the measured power consumed by the client information handling system (e.g., 250 or 270), the duration of such consumption, and a location CO2 emissions rate describing the amount of CO2 or other GHGs emitted during generation of each Watt of power consumed by the client information handling system (e.g., 250 or 270). In embodiments, the recommendation agent 290 may communicate with the CO₂ optimization engine 285 or telemetry 282 to determine such a location CO2 emissions rate for the client information handling systems 250 based on the location given within an indexed and classified JSON incident (e.g., as shown directly above) and stored in telemetry 282. For example, the recommendation agent 290 may communicate with the CO₂ optimization engine 285 or telemetry 282 to determine the location CO2 emissions rate describing the amount of CO2 of other GHGs emitted during generation of each Watt of power consumed by the client information handling system 250 in New Delhi, India (e.g., the location of the client information handling system 250 as shown in the indexed and classified JSON incident) to be 1.82 pounds CO2 per kWh.

In an example embodiment, the CO2 emissions value may be determined using the equation below to determine the CO2 emissions value for the client information handling system 250 operating in New Delhi, India, where the location CO2 emissions rate is 1.82 pounds CO2 per kWh, the power consumed is 200 Watts over a usage time of 16 hours at a battery efficiency of 59% is equivalent to 9.87 pounds CO2 per day:

$$CO 2 Emissions Value = \frac{location CO 2 emissions rate * Power Consumed * Usage Time}{Battery Efficiency}$$

The recommendation agent 290 in an embodiment may perform this determination of CO2 emissions value for each indexed and classified JSON incident it receives from the device index mapper 263 over the CO2 emissions state determination training period. Following such a determination, the recommendation agent 290 may append one or more JSON events indicating the CO2 emissions value within the indexed and classified JSON incident most recently received from the device index mapper 263 and upon which such a determination was made for the client information handling system.

The recommendation agent 290 may also define a CO2 emissions state two threshold value, where CO2 emissions values falling below this CO2 emissions state two threshold value fall within an optimal CO2 emissions state one. The hardware processor may execute code instructions of a recommendation agent to routinely gather indexed and classified JSON incidents from the device index mapper 263 during a training period occurring upon initial purchase of the client information handling system 250 or initial usage, in which the client information handling system 250 is assumed to be operating at optimal efficiency with respect to CO2 emissions. Following this training period, which may have a duration set by the manufacturer or IT manager of the enterprise management system 235, the recommendation agent 290 may determine, for each indexed and classified JSON incident, an amount of CO2 emitted due to power consumed by the client information handling system 250.

The maximum determined CO2 emissions value across all JSON incidents during the training period may form the basis for the CO2 emissions state two transition threshold value. For example, the recommendation agent 290 in an embodiment may determine the CO2 emissions value using the equation used above and an indexed and classified JSON incident identifying a total amount of power consumed by all hardware components of the client information handling system 250. More specifically, in an example embodiment, the CO2 emissions value for the client information handling system 250 operating in New Delhi, India, where the location CO2 emissions rate is 1.82 pounds CO2 per kWh, during the training period immediately following purchase of the client information handling system 250 or its initial use may be equivalent to 2.184 pounds CO2 per day. This may be the case, for example, where the power consumed during one day of the training period is 75 Watts over a usage time of 16 hours at a battery efficiency of 100%. In an embodiment in which this determined CO2 emissions value is the highest CO2 emissions value determined based on JSON incidents gathered during the training period, the recommendation agent 290 may define the CO2 emissions state two transition threshold value to be 2.184 pounds CO2 per day.

The recommendation agent 290 in an embodiment may also determine the three CO2 emissions states in which the client information handling system 250 may operate during its life cycle based on the indexed and classified JSON incident received from device index manager 263. As described herein, the life cycle of each client information handling system (e.g., 250) may be divided into three states. These states include a first, peak-health training state, immediately following initial purchase and use of the device, a monitoring second state in which the client information handling system consistently meets the goal for capping CO2 emissions, and a non-eco-friendly third state in which inefficient operation of the device unrelated to age causes the client information handling system to fail to meet that goal. Each of the threshold CO2 emissions values defining these states may be particular to each client information handling system and its typical usage profile and may take into account the age of each device. The recommendation agent may define each of these states based on a plurality of CO2 determined JSON incidents gathered during the training session.

All indexed and classified JSON incidents gathered during the training period may be grouped into state one, due to the assumption that the client information handling system is operating at peak efficiency with respect to CO2 emissions during this training period. For example, and as described directly above, the CO2 emissions state two transition threshold value may be set to 2.184 pounds CO2 per day. The recommendation agent in an embodiment may determine the CO2 emissions state three transition threshold value based on the state two transition threshold value and a minimum allowable battery efficiency, prior to prompting replacement of the battery. The recommendation agent 290 in an example embodiment may define this minimum allowable battery efficiency at 25%. In such an example embodiment, the recommendation agent 290 anticipates that the battery efficiency may degrade down to 25% before the battery will be replaced. Some decrease in operational efficiency at each client information handling system (e.g., 250) is unavoidable due to wear and tear of components, such as, for example, the battery 244. Thus, the CO2 emitted per hour is expected to increase over time, even when the client device 250 is being used as efficiently as possible, due to decreased efficiency of the battery 244 as it ages. In other words, even if the updating and execution of software and firmware and power consumption of various components (e.g., 220, 242, 243, 245, 246, 247, 248 or 249) are optimized for minimizing CO2 emissions, increases in CO2 emissions during operation of the client information handling system will still occur. The recommendation agent 290 in an embodiment differentiates such unavoidable increases in CO2 emissions due to aging from further increases in CO2 emissions due to avoidable inefficient usage of the client information handling system 250 (e.g., due to failure to perform updates, non-optimized execution of software or firmware, or non-eco-friendly power consumption by hardware components).

The second state in an embodiment may define a maximum CO2 emissions value for the client information handling system 250 when the device is being used as efficiently as possible, but that also takes into account the age of the client information handling system 250 and its components (e.g., battery 244). For example, the recommendation agent 290 in an embodiment in which the CO₂ emissions state two transition threshold value is set at 2.184 pounds CO2 per day and the determined minimum allowable battery efficiency is 25% may determine a CO2 emissions state three transition threshold value of five times the CO2 emissions state two transition threshold value, or 8.736 pounds CO2 per day. This maximum CO2 emissions value defining the second state in embodiments may be referred to herein as a non-eco-friendly state transition threshold value. When operation of the client information handling system 250 causes emission of CO2 beyond this non-eco-friendly state transition threshold value, the client information handling system 250 may pass from the second state to the third, non-eco-friendly state in which inefficient operation of the device unrelated to age causes increased CO2 emissions. In such a way, the recommendation agent 290 may estimate CO2 emissions for optimally efficient usage of the client information handling system 250, given the unavoidable drop in efficiency of its battery.

Returning to the discussion of the monitoring period, following the training period in which the three CO2 emissions states have been defined, the recommendation agent in an embodiment may edit the indexed and classified JSON incident described above with respect to block 318 to include a current monitoring period CO2 emissions value and CO2 emissions state for the client information handling system. For example, the recommendation agent 290 may edit the classified and indexed JSON incident described above with respect to blocks 318 and 320 to generate the below CO2 determined JSON incident:

```
{
  “data” :
  {
    “event_id” : 123460,
    “source_ID” : power_analytics_module,
    “timestamp_unixtime_ms” : 1544145450,
    “client_device_ID” : 456789,
    “client_device_model” : Laptop_7400,
    “location” : New Delhi, India,
    “custom_flags” :
      {
        “fan_workload” : 0.90,
        “testing_application_CPU_usage” : 0.9,
        “background_application_memory_usage” : 0.9,
        “browsing_application_NID_usage” : 0.9,
        “temperature_F” : above_140,
        “CO2_emissions_value_lbsCO2_perday” : 9.87,
        “CO2_emissions_state” : 3,
      }
    “device_current_state :
      {
        “NID_1_type” : WLAN,
        “NID_2_type” : WWAN,
        “NID_2_data_transceived” : 100 GB,
        “NID_3_type” : BT,
        “memory_type” : 16_GB,
        “CPU_type” : X_Series,
        “GPU_type” : G_Series,
        “SSD_type” : 256_GB,
        “Display_type” : 15.6_HD_OLED,
        “fan_driver_version” : 14.2,
        “Display_mode” : high_definition,
        “Camera_type” : webcam,
        “Camera_detection_mode” : continuous_monitor,
        “Camera_capture_mode” : high_resolution,
        “temperature_F” : 142
        “OS_Version” : 10.2,
        “efficiency_battery” : 0.59,
        “usage_time_hours_perday” : 16,
        “fan_power_consumption_watts” : 60,
        “total_power_consumption_watts_perday” : 200,
        “active_browsing_hours_perday” : 15,
        “usage_profile” : hardware_testing,
      }
  }
  “incident_class” : Workload,
  “incident_class” : Temperature,
}
```

At block 324 in an embodiment, the data segregator may determine whether the CO2 determined JSON incident indicates that the client information handling system is operating in state three in one or more recent monitoring periods. Following definition of the CO2 emissions states, as described directly above, a CO2 emissions monitoring period may begin, in which the recommendation agent 290 routinely receives indexed and classified JSON incidents (e.g., as described at block 320), and for each JSON incident received, determines the CO2 emissions value (e.g., as described directly above) and the CO2 emissions state for a current monitoring period indicated by the indexed and classified JSON incident. In an embodiment, the data segregator 266 may determine the CO2 emissions state of the client information handling system 250, based on the determined CO2 emissions value in one or more recent monitoring periods and the defining CO2 emissions state threshold values. For example, the data segregator 266 may determine that the client information handling system 250 that emitted 9.87 pounds CO2 per day, as indicated by a recently received indexed and classified JSON incident described directly above, is operating in the third state, because it is above the CO2 emissions state three threshold value of 8.736 pounds CO2 per day.

If the information handling system is operating within CO2 emissions state three, the device refurbishment CO2 emissions minimization system at the UEM platform may use the operational telemetry measurements for the client information handling system received in the JSON incident described above to predict a cause for the transition of the client information handling system to the non-eco-friendly CO2 emissions state three. The method may then proceed to block 326 for creation of a CO2 state monitoring period JSON incident including such operational telemetry measurements and transmission of that telemetry to the device refurbishment CO2 emissions minimization system. If the information handling system is not operating within CO2 emissions state three (e.g., within either state one, or state two) it may not be yet necessary for the device refurbishment CO2 emissions minimization system at the UEM platform to determine a cause for a transition to the non-eco-friendly state three because such a transition has not yet occurred. In such a case, the data segregator may pro-actively limit transmission of the operational telemetry measurements for the client information handling system to the device refurbishment CO2 emissions minimization system. The method may then end. In such a way, the data segregator may segregate operational telemetry measurements that are useful for predictions made by the device refurbishment CO2 emissions minimization system from those that are not, and may pro-actively limit unnecessary power consumption and transmissions to the UEM platform.

The recommendation agent in an embodiment in which the data segregator determines the client information handling system is operating in CO2 emissions state three may edit the CO2 determined monitoring period JSON incident to include the CO2 emissions state two transition threshold value, CO2 emissions state three transition threshold value, and usage profiles to create a CO2 state monitoring period JSON incident at block 326. For example, the recommendation agent 290 in an embodiment may edit the CO2 determined monitoring period JSON incident generated at block 322 to include the CO2 emissions state two transition threshold value and CO2 emissions state three transition threshold value determined by the recommendation agent, as described above at block 322 to provide the following CO2 state monitoring period JSON incident:

```
{
  “data” :
  {
    “event_id” : 123460,
    “source_ID” : power_analytics_module,
    “timestamp_unixtime_ms” : 1544145450,
    “client_device_ID” : 456789,
    “client_device_model” : Laptop_7400,
    “location” : New Delhi, India,
    “custom_flags” :
      {
        “fan_workload” : 0.90,
        “testing_application_CPU_usage” : 0.9,
        “background_application_memory_usage” : 0.9,
        “browsing_application_NID_usage” : 0.9,
        “temperature_F” : above_140,
        “CO2_emissions_value_lbsCO2_perday” : 9.87,
        “CO2_emissions_state” : 3,
        “CO2emissions_statetwo_threshold” : 2.184,
        “CO2emissions_statethree_threshold” : 8.736,
      }
    “device_current_state :
      {
        “NID_1_type” : WLAN,
        “NID_2_type” : WWAN,
        “NID_2_data_transceived” : 100 GB,
        “NID_3_type” : BT,
        “memory_type” : 16_GB,
        “CPU_type” : X_Series,
        “GPU_type” : G_Series,
        “SSD_type” : 256_GB,
        “Display_type” : 15.6_HD_OLED,
        “fan_driver_version” : 14.2,
        “Display_mode” : high_definition,
        “Camera_type” : webcam,
        “Camera_detection_mode” : continuous_monitor,
        “Camera_capture_mode” : high_resolution,
        “temperature_F” : 142
        “OS_Version” : 10.2,
        “efficiency_battery” : 0.59,
        “usage_time_hours_perday” : 16,
        “fan_power_consumption_watts” : 60,
        “total_power_consumption_watts_perday” : 200,
        “active_browsing_hours_perday” : 15,
        “usage_profile” : hardware_testing,
      }
  }
  “incident_class” : Workload,
  “incident_class” : Temperature,
}
```

As described in greater detail above with respect to FIG. 2, and below with respect to FIGS. 4 and 6, the device CO2 refurbishment CO2 emissions minimization system in an embodiment in which the first client information handling system 250 has been returned to the refurbished device hub 231 of the enterprise management system 235 for replacement may orchestrate such replacement to a second user whose usage profile and geographic location may allow the first client information handling system extend its life and to operate within the eco-friendly CO2 emissions state one or two without replacement of hardware components or adjustments to the new user's usage profile or patterns. The refurbishment CO2 emissions minimization system 280 may generate recommendation instructions for replacement of the first client information handling system 250 to a second user. In order to identify such an appropriate new user or second user for the first client information handling system 250 in an embodiment, the device refurbishment CO2 emissions minimization system 280 may determine a cause for the transition of the first client information handling system 250 to the non-eco-friendly state three during use by the first user (e.g., in New Delhi, India). This CO2 causative operational telemetry measurement or other cause may be determined based on the JSON incident described above with respect to block 326, or predicted failure JSON incidents, as described in greater detail below with respect to FIG. 4.

The CO2 increase causative operational telemetry measurement(s) listed within the predicted failure JSON incident as a predicted cause for the detected transition to the non-eco-friendly CO2 emissions state three at the first client information handling system 250 may be predicted by the CO2 optimization engine 285 in an embodiment using a neural network 286. In an embodiment, the neural network 286 operating at the UEM platform 200 may model a relationship between each of a plurality of user-adjustable operational telemetry measurement values indicated within a first-recorded CO2 state monitoring period JSON incident and the CO2 emissions state indicated within a second, later-recorded CO2 state monitoring period JSON incident. The CO2 optimization system 285 in an embodiment may receive and input into such a trained neural network 286 a CO2 state monitoring period JSON incident from a first client information handling system (e.g., 250) to predict whether the client information handling system (e.g., 250) may transition from state two to the non-eco-friendly state three during any current monitoring period or vice-versa and return to an eco-friendly state two if transferred for replacement to a second user. Such a prediction of CO2 emissions state transition may be based on the input of the CO2 state monitoring period JSON incident generated during a previous monitoring period.

The neural network 286 in an embodiment may be crowd-source trained on other sets of received CO2 state monitoring period JSON incidents from a plurality of client information handling systems (e.g., 250 and 270) using the same frequency of monitoring periods as that used by the information handling system 250. Further, in some embodiments, a separate neural network (e.g., 286) may be trained for each of a plurality of usage profiles for the plurality of client information handling systems and one or more users associated with those client information handling systems, such as the first user and second user in the example embodiments above. For example, such usage profiles may specify the type of activities for which the client information handling system (e.g., 250 or 270) has been purchased. More specifically, example usage profiles may identify the client information handling system 250 as a corporate device used primarily for presentations, accounting, or enterprise-wide communications, or as a testing device used for operational testing of various peripherals or hardware components. In another example, usage profiles may identify the client information handling system 250 as a code-compiling or software application development machine, a device used primarily as a home computer or personal computer, or a device intended for use as a gaming platform. In an example embodiment, this information may be determined based on user input via a GUI during initial startup of the client information handling system (e.g., 250) following its purchase. The data segregator 266 in an example embodiment may include a JSON event named “usage profile” having a value of “corporate,” such as a client information handling system used for corporate administrative functions or any of the other above-described usage profiles or other contemplated usage profiles within the CO2 state monitoring period JSON incident.

In an embodiment in which the client information handling system is associated with a usage profile, the recommendation agent 290 may also include the usage profile within the CO2 determined JSON incident generated at block 322 to create a CO2 state monitoring period JSON incident. The recommendation agent 290 in such an embodiment may then transmit the CO2 state monitoring period JSON incident to the device refurbishment CO2 emissions minimization system 280 or the CO2 optimization engine 285 at the UEM platform 200. The process of blocks 302-326 in various embodiments described herein may be repeated at the end of each monitoring period, thus resulting in the client information handling system 250 transmitting a plurality of CO2 state monitoring period JSON incidents to the device refurbishment CO2 emissions minimization system 280 over time.

Such a process may also be repeated for a plurality of other client information handling systems (e.g., 270) within an enterprise network in an embodiment. For example, as described herein, the device refurbishment CO2 emissions minimization system 280 in an embodiment may also determine whether a second user (e.g., a user of the second information handling system 250) who is requesting to purchase or receive a replacement client information handling system to replace the second client information handling system 250 has a usage profile, pattern, workload, or geographic location likely to allow the first client information handling system 250, when refurbished, to operate within the eco-friendly CO2 emissions state one or two. In order to make this second determination, the device refurbishment CO2 emissions minimization system 280 in an embodiment may refer to JSON incidents gathered by the UEM platform 200 from the second client information handling system 270 during its use by the second user, and prior to the request by such second user to replace the second client information handling system 270 with a replacement client information handling system. In other embodiments, an IT manager or second user may determine that a second client information handling system 270 is in a failed state or a near-failed state and that a replacement client information handling system is required. The UEM platform 200 may have gathered the following JSON incident from the second client information handling system 270 describing operation of the device by the second user, prior to the second user's request or a requirement otherwise arising to replace the second client information handling system 270:

```
{
  “data” :
  “
    “event_id” : 123461,
    “source_ID” : power_analytics_module,
    “timestamp_unixtime_ms” : 1544145451,
    “client_device_ID” : 987654,
    “client_device_model” : Laptop_5400,
    “location” : Paris, France,
    “custom_flags” :
      {
        “videoconferencing_application_NID_usage” : 0.9,
        “CO2_emissions_value_lbsCO2_perday” : 0.093,
        “CO2_emissions_state” : 2,
        “CO2emissions_statetwo_threshold” : 0.065,
        “CO2emissions_statethree_threshold” : 0.26,
      }
    “device_current_state :
      {
        “NID_1_type” : WLAN,
        “NID_2_type” : WWAN,
        “NID_2_data_transceived” : 100 GB,
        “NID_3_type” : BT,
        “memory_type” : 8_GB,
        “CPU_type” : A_Series,
        “GPU_type” : B_Series,
        “SSD_type” : 256_GB,
        “Display_type” : 15.6_HD_OLED,
        “Camera_type” : webcam,
        “OS_Version” : 10.2,
        “efficiency_battery” : 0.7,
        “usage_time_hours_perday” : 8,
        “fan_power_consumption_watts” : 20,
        “total_power_consumption_watts_perday” : 60,
        “active_browsing_hours_perday” : 3,
        “usage_profile” : personal,
      }
  }
  “incident_class” : Config
}
```

These monitoring periods in which JSON incidents are gathered from a plurality of client information handling systems (e.g., 250 and 270) may occur repeatedly throughout the lifecycle of each client information handling system (e.g., 250 and 270) in order to predict, based on gathered CO2 determined JSON incidents, whether the information handling system may imminently shift from state two to the non-eco-friendly state three, or to predict a cause for a client information handling system that has already made such a transition and also assess whether transition back to an eco-friendly CO2 emissions state two is available and how that may occur. The method may then end.

FIG. 4 is a flow diagram illustrating a method of identifying an operational telemetry measurement that may be a user-adjustable operational telemetry measurement as a candidate CO2 increase causative operational telemetry measurement for a previous transition to a non-eco-friendly CO2 emissions state three according to an embodiment of the present disclosure. As described herein, the CO2 optimization engine in an embodiment may routinely predict when a client information handling system is likely to transition to the non-eco-friendly state three during the current monitoring period, and likely causes for such a transition. These predictions and causes may be stored in a predicted failure JSON incident during the lifetime of the client information handling system. Upon a transition to the non-eco-friendly state three and a decision by the current user or an IT manager to upgrade to a new client information handling system, the device refurbishment CO2 emissions minimization system may review these previously stored predicted failure JSON incidents to determine one or more causes of the previous transition (e.g., during use by the current user) of the client information handling system to the non-eco-friendly CO2 emissions state three. This is further used to determine whether the CO2 emissions increase causative operational telemetry measurement is the cause of the transition that may be reversed to place the client information handling system back to an eco-friendly CO2 emissions state two. Based on such a diagnosed cause and as described in greater detail with respect to FIG. 6 below, the device refurbishment CO2 emissions minimization system may prepare the client information handling system for refurbishment for transfer to another user as a replacement information handling system. This replacement is recommended to the second user via a generated recommendation instruction where the second user has a usage profile indicating a low likelihood that the refurbished device will transition to the non-eco-friendly state three due to the same diagnosed cause.

At block 402, the communication agent operating at the UEM platform in an embodiment may receive, and store in telemetry, CO2 state monitoring period JSON incidents from a plurality of client information handling systems over a plurality of monitoring periods. These CO2 state monitoring period JSON incidents may include operational telemetry measurements, including user-adjustable operational telemetry measurements, such as power analytics, software application analytics, and event viewer error logs, as well as determined CO2 emissions values and state transition threshold values unique to each client information handling system. These CO2 state monitoring period JSON incidents may be gathered (e.g., as described above with respect to blocks 314-316 of FIG. 3) during routine monitoring periods from a plurality of client information handling systems at the cloud-based device refurbishment CO2 emissions minimization system. For example, the communication agent 281 in an embodiment described above with respect to FIG. 2 may receive a plurality of CO2 state monitoring period JSON incidents from the first client information handling system 250 and the second client information handling system 270 over a plurality of monitoring periods. More specifically, the communication agent 281 in an embodiment may receive a CO2 state monitoring period JSON incident, similar to that described above at block 326 of FIG. 3 for the first client information handling system 250 during operation by a first user of the first client information handling system (e.g., in New Delhi, India). These CO2 state monitoring period JSON incidents may be received prior to and upon the transition of the first client information handling system 250 to the non-eco-friendly third state. Then those CO2 state monitoring period JSON incidents for the first user of the first client information handling system 250 may be used upon request or an IT manager requirement for replacement of the first client information handling system 250.

The code instructions of the CO2 optimization engine executing on hardware processing resources at the UEM platform in an embodiment at block 404 may predict, via a neural network, that the client information handling system will transition to a non-eco-friendly CO2 emissions state three. The CO2 optimization engine 285 in an embodiment may first input a received CO2 state monitoring period JSON incident from the first client information handling system 250 into a crowd-source trained neural network 286. The CO2 optimization engine 285, for example, may input a CO2 state monitoring period JSON incident similar to that described above at block 326 of FIG. 3 measuring operational telemetry during the previous monitoring period for the client information handling system 250 into the neural network 286 and feed-forward these input values to produce an initial output estimated CO2 emissions value for the first information handling system 250 during the current monitoring period. If the output CO2 emissions value from the neural network 286 exceeds the CO2 emissions state three transition threshold value also included within the received CO2 state monitoring period JSON incident, this may indicate that the neural network 286 predicts that the client information handling system 250 will transition or helps predict why the transition from state two to the non-eco-friendly state three during the current monitoring period occurs. As described in greater detail below, upon predicting that the client information handling system 250 may transition or has transitioned to the non-eco-friendly state three during a current monitoring period, the CO2 optimization engine 285 may determine one or more CO2 increase causative operational telemetry measurements likely to be the cause for such a transition. As also described in greater detail herein, the client information handling system 250 may ultimately transition to the non-eco-friendly state three as predicted, leading to the first user or an IT manager requesting replacement of the first client information handling system 250 with a new client information handling system capable of maintaining the eco-friendly states one or two and providing workload capacity during use by the first user at her location.

At block 406, the CO2 optimization engine in an embodiment may identify a predicted candidate client device operation cause for a predicted transition of the client information handling system to the non-eco-friendly CO2 emissions state three. In some embodiments, the CO2 state monitoring period JSON incident received at block 402 may indicate failure of one or more hardware components as CO2 increase causative operational telemetry measurements contributing to or causing the predicted transition to the non-eco-friendly state three. A systems internal health assessor (SIHA) 283 operating at the UEM platform 280 in an example embodiment may determine whether a hardware component failure is indicated within the most recently received CO2 state monitoring period JSON incident. For example, the SIHA 283 operating at the UEM platform 200 in an embodiment may identify the CO2 state monitoring period JSON incident received at block 402 as indicating failure of a hardware component of a given hardware type, or substantial functional inefficiency, as described above in greater detail with respect to FIG. 2.

The CO2 optimization engine 285 in an embodiment may identify the operational telemetry measurement types associated with the failed hardware component identified as a candidate CO2 increase causative operational telemetry measurements. For example, in an embodiment in which the SIHA 283 has identified failure of the fan, the CO2 optimization engine 285 may identify each JSON event having a name that includes the word “fan” within the most recently received CO2 state monitoring period JSON incident. More specifically, the CO2 optimization engine 285 may identify the JSON event “fan_driver_version” to determine whether this JSON event is associated with a known remediation user instruction for adjusting the value associated with the JSON event “fan_driver_version” to pro-actively limit transition to the non-eco-friendly CO2 emissions state three. This may be repeated for each hardware component (e.g., 220, 242, 243, 244, 245, 246, 247, 248, or 249) that the SIHA 283 may have identified as failing.

In other embodiments, failure or underperformance of any given hardware component may not be the cause of the predicted transition to the non-eco-friendly state three. In such a scenario, in an embodiment in which the SIHA does not identify a hardware component failure, the CO2 optimization engine 285 may identify remediation user instructions not associated with failing hardware components as candidate CO2 increase causative operational telemetry measurements. For example, even if the SIHA 283 does not identify a failure of the fan 243, GPU 242, memory 246, network interface device 222, or any other hardware component, the CO2 optimization engine 285 may still identify any JSON events having names including any of these components (e.g., “fan_driver_version”) as a candidate CO2 increase causative operational telemetry measurement, if that JSON event name is adjustable by a user. For example, telemetry 282 may store a JSON event name “OS_version” shown in the CO2 state monitoring period JSON incident as user adjustable through a remediation user instruction to update the version of the operating system installed at the client information handling system 250. As another example, telemetry 282 may identify a JSON event name “active_browsing_hours_perday” shown in the CO2 state monitoring period JSON incident as user adjustable through a remediation user instruction to cap the number of active browsing windows or amount of time windows are left active for browsing the internet.

These are only a few examples of JSON event names associated with user-adjustable operational telemetry measurements. It is contemplated that telemetry 282 in other embodiments may store identification of user-adjustable operational telemetry measurement identified through the name of a JSON event within CO2 state monitoring period JSON incidents and the name of the JSON event. For example, other embodiments contemplate operational telemetry measurements adjustable by changing any hardware policy settings or software application policy settings controllable by the power analytics module 240 or application analytics module 230 as user-adjustable operational telemetry measurements.

The CO2 optimization engine in an embodiment at block 408 in which the neural network has predicted the client information handling system will or has transitioned to the non-eco-friendly CO2 emissions state three within the current monitoring period may store a predicted failure JSON incident in telemetry. Upon determination of one or more candidate CO2 increase causative operational telemetry measurements (e.g., as associated with a hardware failure, or not associated with specific hardware failure), the CO2 optimization engine 285 in an embodiment may generate and store in telemetry a predicted failure JSON incident. Such a predicted failure JSON incident in an embodiment may identify the most recently received CO2 state monitoring period JSON incident input into the neural network to cause the predicted or already occurred transition to the non-eco-friendly CO2 emissions state three and each of the identified candidate CO2 increase causative operational telemetry measurements. For example, the CO2 optimization engine 285 may generate a predicted failure JSON incident in an embodiment including the identified candidate CO2 increase causative operational telemetry measurements “fan_workload” having a value over 80%, “temperature_F” having a value over 140, or “testing_application_CPU_usage” having a value over 85%. This may indicate that the CO2 optimization engine 285 has predicted that one or more of these candidate CO2 increase causative operational telemetry measurements are predicted to occur within the current monitoring period, and to cause the first client information handling system 250 to transition to the non-eco-friendly CO2 emissions state three.

At block 410, the device refurbishment CO2 emissions minimization system in an embodiment may receive an updated JSON incident indicating that the first client information handling system has transition to the non-eco-friendly CO2 emissions state three and identifying occurrence of one or more candidate CO2 increase causative operational telemetry measurements. For example, in an embodiment in which, prior to the first client information handling system transitioning to the third non-eco-friendly CO2 emission state, the predicted failure JSON incident identifies candidate CO2 increase causative operational telemetry measurements “fan_workload” having a value over 80%, “temperature_F” having a value over 140, or “testing_application_CPU_usage” having a value over 85%, the device refurbishment CO2 emissions minimization system 280 may receive the JSON incident described above at block 326 of FIG. 3. In such an embodiment, the device refurbishment CO2 emissions minimization system 280 may identify that the first client information handling system 250 has crossed into the non-eco-friendly CO2 emissions state three by the JSON event named “CO2_emmissions_state” having a value of 3. These candidate CO2 increase causative operational telemetry measurements may be user-adjustable, but the first user may be unwilling or unable to make such adjustments with the intended usage profile or purpose of the first client information handling system.

The device refurbishment CO2 emissions minimization system 280 in an embodiment may also identify occurrence of the candidate CO2 increase causative operational telemetry measurements “fan_workload” having a value of 0.9, above the threshold value of 0.8 identified within the predicted failure JSON incident (e.g., described directly above with respect to block 408). In another example, the device refurbishment CO2 emissions minimization system 280 in an embodiment may also identify occurrence of the candidate CO2 increase causative operational telemetry measurements “temperature_F” having a value of 142, above the threshold value of 140 identified within the predicted failure JSON incident. In still another example, the device refurbishment CO2 emissions minimization system 280 in an embodiment may also identify occurrence of the candidate CO2 increase causative operational telemetry measurements “testing_application_CPU_usage” having a value of 0.9, above the threshold value of 0.85 identified within the predicted failure JSON incident. In other embodiments, only one of these candidate CO2 increase causative operational telemetry measurements may be indicated as having occurred within the updated CO2 state monitoring period JSON incident received. Each of the candidate CO2 increase causative operational telemetry measurements identified within the updated CO2 state monitoring period JSON incident that also indicates the first client information handling system 250 has transitioned to the non-eco-friendly CO2 emissions state three may then be identified by the device refurbishment CO2 emissions minimization system 280 as a CO2 increase causative operational telemetry measurement that may be reversed in a second user's usage profile to permit extended life of the first client information handling system without the need for changes to a second user's usage profile.

At block 412, the device refurbishment CO2 emissions minimization system in an embodiment may receive a request for replacement of the first client information handling system with a new or refurbished client information handling system. For example, a first user of the first client information handling system 250 or an IT manager may request a new or refurbished client information handling system to replace the first client information handling system 250 that is capable of meeting user needs while maintaining an eco-friendly state one or two. Similarly, a second user or an IT manager may request replacement of the second client information handling system. The device refurbishment CO2 emissions minimization system may determine if the refurbished first client information handling system may meet the second user's needs without changes to the second user's usage profile as described further in embodiments herein. The method for identifying a user-adjustable operational telemetry measurement as a candidate client device operation cause for a prediction that a client information handling system will transition to a non-eco-friendly CO2 emissions state three may then end.

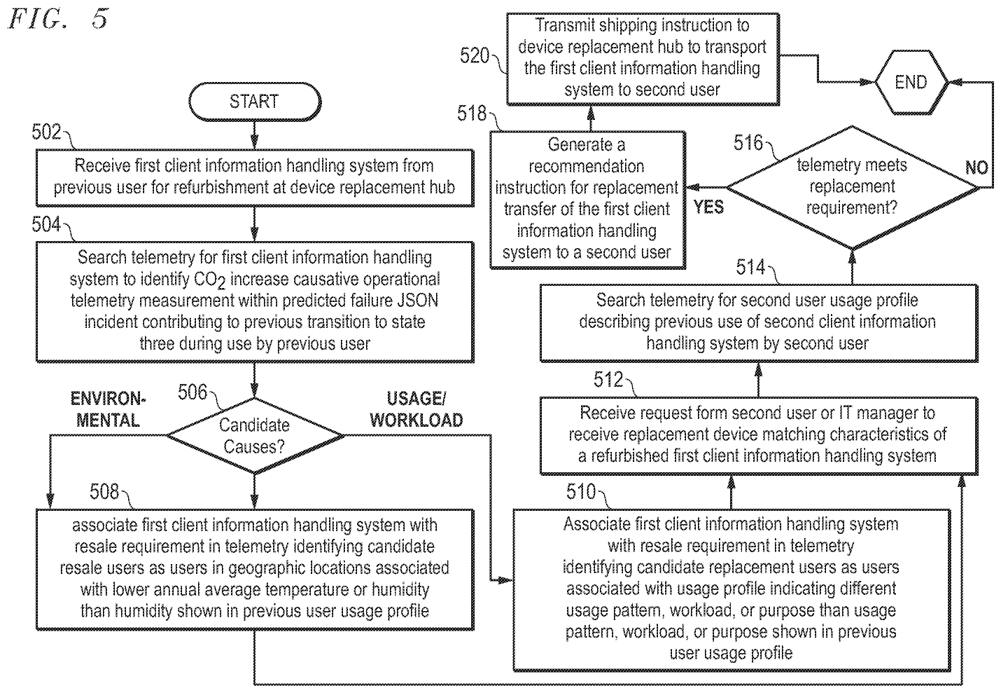

FIG. 5 is a flow diagram illustrating a method of orchestrating, with generating a replacement recommendation instruction, the refurbishment of client information handling systems according to usage profiles of previous and future candidate users at a unified endpoint management (UEM) platform according to an embodiment of the present disclosure. As described herein, the device refurbishment CO2 emissions minimization system in embodiments of the present disclosure may orchestrate, by generating instructions for refurbishment and replacement of client information handling systems to users likely to maintain the client information handling system within the eco-friendly CO2 emissions state one or two without adjusting hardware configuration or intended usage of the client information handling system by the new, second user.

At block 502, the device replacement hub in an embodiment may receive the first client information handling system from a previous user for refurbishment and replacement. For example, as described above with respect to block 412 and with respect to an embodiment described with respect to FIG. 2, a first user of the first client information handling system 250 or an IT manager may request a new or refurbished client information handling system to replace the first client information handling system 250 once the first client information handling system 250 transitions to the non-eco-friendly CO2 emissions state two. A second user of a second client information handling system 270 may also request replacement of the second client information handling system 270 in an embodiment for a variety of reasons.

The device refurbishment CO2 emissions minimization system in an embodiment at block 504 may search telemetry for the first client information handling system. As described herein, the device refurbishment CO2 emissions minimization system 280 may orchestrate, by generating instructions for refurbishment and replacement of client information handling systems (e.g., 250) to users (e.g., user of client information handling system 270) likely to maintain the client information handling system 250 within the eco-friendly CO2 emissions state one or two. In order to do so, the device refurbishment CO2 emissions minimization system 280 may determine a cause for the first client information handling system's 250 transition to the non-eco-friendly CO2 emissions state three during usage by a first user. For example, the device refurbishment CO2 emissions minimization system 280 in an embodiment may search telemetry 282 for one or more CO2 increase causative operational telemetry measurements within predicted failure JSON incidents associated with the first client information handling system 250 confirmed to have occurred prior to or following the transition to the non-eco-friendly CO2 emissions state three. More specifically, the device refurbishment CO2 emission minimization system 280 may identify one or more of the CO2 increase causative operational telemetry measurements identified at block 410 of FIG. 4.

At block 506, the device refurbishment CO2 emissions minimization system may determine whether the CO2 increase causative operational telemetry measurements indicate an environmental effect such as temperature or humidity, or a usage-related effect such as usage or heavy-workload effect. Certain CO2 increase causative operational telemetry measurements in an embodiment may be associated in telemetry 282 with environmental effects, or with usage or heavy-workload effects. For example, any CO2 increase causative operational telemetry measurements related to temperature or heavy workload on cooling mechanisms such as fans 244 may be associated with environmental effects. More specifically, a CO2 increase causative operational telemetry measurement indicated by a JSON event named “temperature_F” having a value of 142, above the threshold value of 140 may be associated with environmental effects caused by high ambient temperature or humidity for the geographic location (e.g., New Delhi, India) in which the first client information handling system 250 was operated by the first user. In another example, a CO2 increase causative operational telemetry measurement indicated by a JSON event named “fan_workload” having a value of 0.9, above the threshold value of 0.8 may be associated with environmental effects caused by high ambient temperature or humidity for the geographic location (e.g., New Delhi, India) in which the first client information handling system 250 was operated by the first user requiring a higher workload on a fan. In other embodiments, a CO2 increase causative operational telemetry measurement indicated by a JSON event named “testing_application_CPU_usage” having a value of 0.9, above the threshold value of 0.85 may be associated with a workload placed on the first client information handling system 250 during operation by the first user.

In some embodiments, classifications of candidate CO2 increase causative operational telemetry measurements within the CO2 state monitoring period JSON incident upon which the predicted failure JSON incident is based (e.g., JSON incident described above with respect to block 326 of FIG. 3) may help to determine whether the cause of the transition to the CO2 emissions state three is due to environmental or workload/usage-related effects. For example, the CO2 state monitoring period JSON incident described above with respect to FIG. 3 at block 326 may classify the incident as “workload,” indicating a high workload on one or more hardware components (e.g., CPU). Such an indicator may lead the device refurbishment CO2 emissions minimization system 280 to identify the CO2 increase causative operational telemetry measurement as a usage or workload-related effect. In another example, the CO2 state monitoring period JSON incident described above with respect to FIG. 3 at block 326 may classify the incident as “temperature,” indicating a high internal temperature (e.g., above 140 degrees Fahrenheit or another temperature threshold) for the client information handling system 250. Such an indicator may lead the device refurbishment CO2 emissions minimization system 280 to identify the CO2 increase causative operational telemetry measurement as an environmental effect. If the device refurbishment CO2 emissions minimization system determines the CO2 increase causative operational telemetry measurement is associated with an environmental effect, the method may proceed to block 508 to identify a replacement requirement that will ensure replacement and transfer to locations with lower environmental temperature or humidity. If the device refurbishment CO2 emissions minimization system determines the CO2 increase causative operational telemetry measurement is associated with a usage or workload effect, the method may proceed to block 508 to identify a replacement requirement that will ensure replacement and transfer to users with different usage profiles indicating different workloads on the whole client information handling system or on one or more particular hardware components than that placed on the first client information handling system 250 by the first user.

In an embodiment in which it is determined that the causative operational telemetry measurement is associated with an environmental effect, the device refurbishment CO2 emissions minimization system at block 508 may associate the first client information handling system with a replacement requirement in telemetry identifying candidate replacement users as users in geographic locations having a lower annual average temperature or humidity than that of the geographic location for the first user. For example, in an embodiment in which it is determined the causative operational telemetry measurement is the temperature above 140 degrees Fahrenheit or some other temperature threshold, or high workload on the fan, as described above with respect to block 506, the device refurbishment CO2 emissions minimization system may set a replacement requirement in telemetry 282 limiting sale or delivery of the first client information handling system 250 to geographic locations having a lower annual average temperature or humidity than that of New Delhi, India. More specifically, the device refurbishment CO2 emissions minimization system may set a replacement requirement in telemetry 282 limiting sale or delivery of the first client information handling system 250 to geographic locations in Europe or North America. The method may then proceed to block 512 for receipt of a request by a second user or IT manager to receive a replacement device to replace a second client information handling system.

At block 510, in an embodiment in which it is determined the CO2 increase causative operational telemetry measurement is associated with a usage or workload effect, the device refurbishment CO2 emissions minimization system may associate the first client information handling system with a replacement requirement in telemetry to identify candidate replacement users as users associated with usage profiles indicating different usage pattern, workload, or purpose than the usage pattern, workload, or purpose shown in the first user's usage profile. For example, in an embodiment in which the CO2 increase causative operational telemetry measurement is a high workload on the CPU by a testing application, the device refurbishment CO2 emissions minimization system may limit replacement or delivery of the first client information handling system 250 to users having a usage profile other than “hardware testing,” as indicated within the CO2 state monitoring period JSON incident described with reference to block 326 of FIG. 3. More specifically, the device refurbishment CO2 emissions minimization system may limit replacement or delivery of the first client information handling system 250 to users having a usage profile of “corporate,” “personal,” or “code compiling” in which high workloads on the CPU may be less likely. In other embodiments, in which the first user of the first client information handling system 250 has a usage profile of “code compiling,” the device refurbishment CO2 emissions minimization system may limit replacement or delivery of the first client information handling system 250 to users having a usage profile of “corporate,” or “personal,” in which high workloads on the CPU may be less likely. In another embodiment, in which the first user of the first client information handling system 250 has a usage profile of “gaming,” and a high workload on the GPU is detected, the device refurbishment CO2 emissions minimization system may limit replacement or delivery of the first client information handling system 250 to users having a usage profile of “corporate,” or “personal,” in which high workloads on the GPU may be less likely. In yet another embodiment, in which the first user of the first client information handling system 250 has a usage profile of “corporate,” the device refurbishment CO2 emissions minimization system may limit replacement or delivery of the first client information handling system 250 to users having a usage profile of “personal,” in which high workloads on any given hardware component may be less likely.

In other embodiments, the device refurbishment CO2 emissions minimization system may limit replacement or delivery of the first client information handling system to users not likely to place the same high workload on specific hardware components of the first client information handling system as that applied by the first user. For example, in an embodiment, the CO2 state monitoring period JSON incident that produced the predicted transition to the non-eco-friendly state three or the predicted failure JSON incident may include a high workload on a specific hardware component (e.g., CPU 242, GPU 242, memory 246, network interface device 222, display 245, battery 244, or camera 247) determined as a CO2 increase causative operational telemetry measurement. In such an embodiment, the device refurbishment CO2 emissions minimization system may limit replacement or delivery of the first client information handling system 250 to users, such as a second user, who have not applied the same high workload on the same type of hardware component at other client information handling systems (e.g., 270) based on their assessed user profiles. The method may then proceed to block 512 for receipt of a request by a second user to receive a refurbished device.

The device refurbishment CO2 emissions minimization system in an embodiment at block 512 may receive a request from a second user or an IT manager to purchase or receive a replacement device matching the characteristics of the first client information handling system as refurbished. For example, such a request may be received via an online shopping portal. In another example, such a request may be transmitted from the second user of a second client information handling system 270 to an IT professional within the enterprise management system 235. In yet another example, an IT professional within the enterprise management system 235 may lodge such a request on behalf of the second user of the second client information handling system 270 upon failed attempts to remediate poor or under-performance of the second client information handling system 270.

At block 514, the device refurbishment CO2 emissions minimization system in an embodiment may search telemetry for second user usage profiles describing previous use of the second client information handling system by the second user. As described herein, the device refurbishment CO2 emissions minimization system may limit replacement or delivery of the first client information handling system 250, which may match the attributes required by the second user at block 512 above, to a candidate second user meeting the replacement requirements set at block 508 or 510 above. The device refurbishment CO2 emissions minimization system 280 in an embodiment may search telemetry 282 to identify a usage profile for the second user of the second client information handling system 270. As described in greater detail above with respect to FIG. 3 at block 326, the UEM platform 200 may gather such telemetry from the second client information handling system 270 during routine monitoring intervals. For example, the device refurbishment CO2 emissions minimization system 280 may reference such telemetry to identify a location for the second user (e.g., Paris, France), usage profiles (e.g., “personal”), or high workload warnings on various hardware components from JSON incidents for the second user when using the second client information handling system. In an example embodiment, the telemetry for the second client information handling system 270 operated by the second user may indicate a high workload on one or more hardware components (e.g., CPU 242, GPU 242, memory 246, network interface device 222, display 245, battery 244, or camera 247).

The device refurbishment CO2 emissions minimization system in an embodiment at block 516 may determine whether the retrieved telemetry associated with the second user meets the replacement requirements set for the first client information handling system. For example, in an embodiment, the device refurbishment CO2 emissions minimization system may have set a replacement requirement at block 508 limiting delivery of the first client information handling system to geographic locations associated with lower annual average temperature or humidity than geographic location of the first user. In such an example embodiment, the device refurbishment CO2 emissions minimization system may determine that the location for the second user (e.g., Paris, France) is associated with lower annual average temperature or humidity than the geographic location (e.g., New Delhi, India) of the first user from a database or online source with average weather or temperature and humidity at the second location.

In another example embodiment, the device refurbishment CO2 emissions minimization system may have set a replacement requirement at block 510 limiting delivery of the first client information handling system to users associated with a different usage profile or workload than that of the first user. In such an example embodiment, the device refurbishment CO2 emissions minimization system may determine the second client information handling system 270 telemetry indicating a usage profile of “personal” for a second user is sufficiently different from the usage profile “hardware_testing” associated with the first user of the first client information handling system 250. In another example embodiment, the device refurbishment CO2 emissions minimization system may determine a second client information handling system telemetry indicating a usage profile of “personal” or “corporate” for a second user is sufficiently different from the usage profile “code_compiling” or “gaming” associated with a first user of a first client information handling system. In still another example embodiment, the device refurbishment CO2 emissions minimization system may determine a second client information handling system telemetry indicating a usage profile of “personal” is different from the usage profile “corporate” associated with a first user of a first client information handling system. These usage profile differences may provide for a lower level of power or resource usage from a second identified user such that a generated recommendation instruction resulting in replacement of the first client information handling system with the second user may cause the refurbished first client information handling system to operate at an eco-friendly CO2 emissions state two or one. In this way, a successful replacement transfer of the first client information handling system to a second user may extend the usable life of the first client information handling system.

In other embodiments, the device refurbishment CO2 emissions minimization system may ensure the second user of the second client information handling system is not likely to place the same high workload on the same hardware components as identified in telemetry for the first client information handling system during use by the first user. For example, the device refurbishment CO2 emissions minimization system in an embodiment at block 510 may have limited replacement or delivery of the first client information handling system 250 to users not likely to place the same high workload on specific hardware components (e.g., CPU 242, GPU 242, memory 246, network interface device 222, display 245, battery 244, or camera 247) of the first client information handling system 250 as that applied by the first user. In such an embodiment, the device refurbishment CO2 emissions minimization system may determine whether telemetry for the second client information handling system 270 includes any indication of high workload on any of these identified hardware components (e.g., “gaming_application_GPU_usage”). If the telemetry for the second client information handling system 270 meets replacement requirements set by the device refurbishment CO2 emissions minimization system to extend the usable life of the first client information handling system, this may indicate that the second user is likely to use the first client information handling system in such a way, and in an environment that may allow the first client information handling system to remain in an eco-friendly CO2 emissions state one or two.

The method may then proceed to block 518 for recommendation of replacement and transfer of the first client information handling system to the second user. If the telemetry for the second client information handling system 270 meets replacement or delivery requirements set by the device refurbishment CO2 emissions minimization system, this may indicate that the second user is not likely to use the first client information handling system in such a way, and in an environment that may allow the first client information handling system to remain in an eco-friendly CO2 emissions state one or two. In such a case, the device refurbishment CO2 emissions minimization system may not recommend replacement of the first client information handling system to the second user, and the method may then end.

In an embodiment in which telemetry for the second client information handling system 270 meets replacement requirements, the device refurbishment CO2 emissions minimization system at block 518 may recommend replacement and transfer of the first client information handling system to the second user. For example, the device refurbishment CO2 emissions minimization system may generate a replacement recommendation instruction to identify the first client information handling system and the second user for which a replacement transfer is recommended to satisfy the replacement need of the second user. In such an example embodiment, the device refurbishment CO2 emissions minimization system 280 in an embodiment may transmit the replacement recommendation instruction to the second client information handling system 270 for display via a GUI, or to an IT manager at the enterprise management system 235 or even to the first client information handling system 250 for display via GUI 291, that the first client information handling system 250 is recommended for replacement and delivery to the second user. Such an indication may also include a price reduction in comparison to the purchase of a new client information handling system, available GHG emissions credits, or some other incentive.

At block 520, the device refurbishment CO2 emissions minimization system may transmit a shipping instruction to the device replacement hub to transport the first client information handling system to the second user. This may occur, in an example embodiment in which the device refurbishment CO2 emissions minimization system receives a second user selection of the first client information handling system 250 for purchase from the second client information handling system 270. In another embodiment, this process may be automated in a situation in which an IT professional of the enterprise management system 235 is controlling such a replacement procedure. For example, upon identification of the second user as a suitable owner, user, or purchaser of the first client information handling system 250 by an IT professional, the device refurbishment CO2 emissions minimization system 280 may automatically transmit a shipping instruction to the device replacement hub 231 to transport the first client information handling system 250 to the second user for replacement of the second client information handling system 270. In such a way, the device refurbishment CO2 emissions minimization system may orchestrate, by generating instructions for refurbishment and replacement of client information handling systems to users likely to maintain the client information handling system within the eco-friendly CO2 emissions state one or two without adjusting hardware configuration or intended usage of the client information handling system. In this way, a successful replacement transfer of a first client information handling system to a suitable second user may extend the usable life of the first information handling system that may also still operate in an eco-friendly cO2 emissions state. This avoids disposal and further CO2 emissions in production and delivery of yet another information handling system as well as avoid or postpone waste buildup of electronics. The method for orchestrating refurbishment of client information handling systems according to usage profiles of previous and future candidate users at a UEM platform may then end.

Returning to block 516, if the telemetry retrieved for a second user does not meet the replacement requirements of the first client information handling system, the method may then end. The method of FIG. 5 may begin again, in some embodiments, for another new candidate replacement user.

The blocks of the flow diagrams of FIGS. 3, 4, and 5 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another may communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A device refurbishment carbon dioxide (CO2) emissions minimization system executing on a unified endpoint management (UEM) platform information handling system comprising:
a network interface device to receive operational telemetry measurements for a first client information handling system operated by a first user, including power analytics, software application analytics, a first user geographic location, and a determined CO2 emissions value exceeding a non-eco-friendly state transition threshold value determined for the first client information handling system;
a hardware processor executing code instructions of the device refurbishment CO2 emissions minimization system to identify, via a neural network modeling a relationship between changes in CO2 emissions values and changes in the operational telemetry measurements, a CO2 increase causative operational telemetry measurement dependent upon the first user geographic location contributing to the determined CO2 emissions value; and
the hardware processor to determine that the first user geographic location has a first annual average temperature that is higher than a second annual average temperature for a second user geographic location of a second information handling system; and
the network interface device to generate and transmit recommendation instructions for display at the second client information handling system that the first client information handling system is recommended for replacement of the first client information handling system to a second user.

2. The information handling system of claim 1, wherein the determined CO2 emissions value is determined at the first client information handling system based on power consumption and physical location of the first client information handling system, indicating CO2 used in generating power for the first client information handling system.

3. The information handling system of claim 1 further comprising:
the network interface device to transmit a shipping instruction to a device replacement hub to transport the first client information handling system to the second user at second user geographic location.

4. The information handling system of claim 1, wherein the second user geographic location has a lower annual average humidity than the first user geographic location.

5. The information handling system of claim 1, wherein the non-eco-friendly state transition threshold value is determined at the first client information handling system based on battery power consumption efficiency loss.

6. The information handling system of claim 1, wherein the non-eco-friendly state transition threshold value is determined at the first client information handling system based on battery age.

7. The information handling system of claim 1, wherein the non-eco-friendly state transition threshold value is determined at the first client information handling system based on testing telemetry measurements, including power analytics, software application analytics, and a determined CO2 emissions value measured during a preset testing period.

8. A method for minimizing carbon dioxide (CO2) emissions with recommended refurbishment and replacement of a first client information handling system comprising:
receiving, via a network interface device, operational telemetry measurements for a first client information handling system operated by a first user, including power analytics, software application analytics, a first user usage profile, and a determined CO2 emissions value exceeding a non-eco-friendly state transition threshold value determined for the first client information handling system;
executing code instructions of the device refurbishment CO2 emissions minimization system, via a hardware processor, to identify, via a neural network modeling a relationship between changes in CO2 emissions values and changes in the operational telemetry measurements, a CO2 increase causative operational telemetry measurement contributing to the determined CO2 emissions value that is dependent upon a workload placed on the first client information handling system;
determining that a second user usage profile associated with a second user of a second client information handling system differs from the first user usage profile with respect to workload placed on the second client information handling system; and
transmitting, via the network interface device, generated recommendation instructions for display at the second client information handling system that the first client information handling system is recommended for replacement of the second client information handling system to the second user.

9. The method of claim 8, wherein the first user usage profile indicates use of the first client information handling system in testing hardware components or peripheral devices and the second user usage profile indicates use of the second client information handling system as a personal device or for corporate administrative purposes.

10. The method of claim 8, wherein the first user usage profile indicates use of the first client information handling system in development, testing, or compiling of software application code and the second user usage profile indicates use of the second client information handling system as a personal device or for corporate administrative purposes.

11. The method of claim 8, wherein the first user usage profile indicates use of the first client information handling system in online gaming and the second user usage profile indicates use of the second client information handling system as a personal device or for corporate administrative purposes.

12. The method of claim 8, wherein the first user usage profile indicates use of the first client information handling system for corporate administrative purposes and the second user usage profile indicates use of the second client information handling system as a personal device.

13. The method of claim 8, wherein the first user usage profile includes a first user purpose of the first client information handling system by the first user that involves greater hardware resource utilization than the second user usage profile having a second user purpose of the second client information handling system by the second user.

14. A device refurbishment carbon dioxide (CO2) emissions minimization system executing on a unified endpoint management (UEM) platform information handling system comprising:
a network interface device to receive first operational telemetry measurements for a first client information handling system operated by a first user, including first power analytics, first software application analytics, a first user usage profile, and a first determined CO2 emissions value exceeding a non-eco-friendly state transition threshold value determined for the first client information handling system;
the network interface device to receive second operational telemetry measurements for a second client information handling system operated by a second user, including second power analytics and second software application analytics;
a hardware processor executing code instructions of the device refurbishment CO2 emissions minimization system to identify, via a neural network modeling a relationship between changes in CO2 emissions values and changes in the first operational telemetry measurements, a CO2 increase causative operational telemetry measurement contributing to the first determined CO2 emissions value that is dependent upon a workload placed on a hardware component of the first client information handling system, of a hardware type, by the first user;
the hardware processor to determine the first user previously rejected a recommendation to cap resources of the hardware component of the hardware type consumed during execution of a software or firmware application at a maximum resource threshold value;
the hardware processor to determine the second operational telemetry measurements indicate previous consumption of resources for the hardware type during use by the second user below the maximum resource threshold value; and
the network interface device to generate and transmit recommendation instructions for display at the second client information handling system that the first client information handling system is recommended for replacement of the second client information handling system to the second user.

15. The information handling system of claim 14, wherein the hardware type is a memory.

16. The information handling system of claim 14, wherein the hardware type is a hardware processor.

17. The information handling system of claim 14, wherein the hardware type is a network interface device.

18. The information handling system of claim 14, wherein the hardware type is a display.

19. The information handling system of claim 14, wherein the hardware type is a battery.

20. The information handling system of claim 15, wherein the hardware type is a camera.
